(19) United States
(12) Patent Application Publication
(10) Pub. No.: US 2017/0278333 A1
(43) Pub. Date: Sep. 28, 2017

(54) PRODUCT AUTHENTICATION AND ITEM IDENTIFICATION

(71) Applicant: AUTHENTIFORM TECHNOLOGIES, LLC, Chapel Hill, NC (US)

(72) Inventors: Thomas J. Mercolino, Chapel Hill, NC (US); Hersh Ashok Tapadia, Raleigh, NC (US); Amy L. McPherson, Raleigh, NC (US); Darrell J. Freeman, JR., Madison, NC (US)

(21) Appl. No.: 15/438,621

(22) Filed: Feb. 21, 2017

Related U.S. Application Data
(63) Continuation of application No. 13/457,115, filed on Apr. 26, 2012, now abandoned.
(60) Provisional application No. 61/479,380, filed on Apr. 26, 2011.

(51) Int. Cl. G07D 7/004; G07D 7/20; G07D 7/005

(52) U.S. Cl. CPC G07D 7/004; G07D 7/0054; G07D 7/20

(57) ABSTRACT

The present invention provides methods, reagents, and apparatus for authenticating and identifying products. Methods of the invention are easy to implement but difficult to replicate, simulate, alter, transpose, or tamper with. In some embodiments, the present invention relates to a product authentication code defined by a frequency array of a population of entities, and an item identifier defined by the specific manifestation of the product authentication code.

### CROSS REFERENCE TO RELATED APPLICATIONS

This application claims priority to U.S. Utility Application Ser. No. 13/457,115, filed Apr. 26, 2012, entitled “Product Authentication and Item Identification”, which claims priority to U.S. Provisional Application Ser. No. 61/479,380, filed Apr. 26, 2011, entitled “Product Authentication and Item Identification”, the entire disclosure of which is hereby incorporated by reference in its entirety, and the benefit of the filing date of which is hereby claimed for all purposes that are legally served by such claim.

### FIELD OF THE INVENTION

The invention is in the general field of methods and apparatus for authenticating and identifying products. In particular, the invention relates to an authentication and identification of an article using codes defined by a frequency array of a population of entities. More particularly, the invention relates to authentication and identification of signatures and text in documents subject to fraudulent changes thereto, such as prescriptions for narcotic analgesics.

### BACKGROUND OF THE INVENTION

Product authentication is the means whereby a legitimate product may be distinguished from a counterfeited fake designed to resemble the genuine article. Product authentication also plays a critical role in distinguishing diverted or “gray market” products, which are by definition legitimately manufactured products distributed into markets other than originally intended in violation of a contract, law or regulation. Closely linked to product authentication are “track and trace” of product movement in the supply chain from manufacturer to intermediary suppliers and retailers to end customers.

Further, product identification at the item level is desirable in cases where an individual instance of like products must be distinguished from all other instances of that product. A person's signature affixed to a document, whether done so manually or through digital processes, falls into this latter category.

Also useful is the authentication and identification of text in documents subject to changes. In general, any document of value is subject to changes for fraudulent purposes. Examples include prescriptions for controlled substances like narcotic analgesics, medical records, supply chain documents like customs forms and manifests, and academic records like transcripts, letters of recommendation, and diplomas.

Fueled in part by growing trade over the Internet, counterfeiting is a major, growing worldwide problem. Counterfeit products are estimated to comprise 5-7% of global commerce. In response to the growth in counterfeit products, the anti-counterfeiting and brand protection market is expected to grow globally at a compound annual growth rate of 15% between 2010 and 2015.

Drug counterfeiting has become a significant issue in the healthcare community and the pharmaceutical industry worldwide. In the absence of safety regulations imposed upon authentic equivalents, counterfeit drugs often have substandard drug quality or quantity, or harmful ingredients, exposing patients to corresponding health risks. For example, counterfeit forms of medicine intended to treat malaria and tuberculosis, alone, result in more than 700,000 deaths/year and countless additional injuries. Moreover, counterfeiting results in a loss of revenue for legitimate pharmaceutical companies and associated morbidities cause global economic harm. Sales of counterfeit medicines are growing at an estimated 13% annual rate to $75 billion by 2012, compared to 7.5% estimated annual growth for legitimate pharmaceutical commerce. Factoring in the cost of lost sales to pharmaceutical companies, the daily cost of in-hospital patients, and the health cost of misdiagnosis caused by fake medicines camouflaging genuine symptoms, in the EU alone these total costs were at least [symbol] 50bn in 2007.

Problems of product diversion are closely related to frank counterfeiting. Product diversion can occur relatively readily in the pharmaceutical business because contract manufacture, packaging and repackaging is a big and growing part of the legitimate supply chain; these practices allow for cost control, local language packaging and customization to local customer preferences, for example. Suppliers can't be held fully accountable for roles an unscrupulous few play in the counterfeit trade, because these otherwise desirable practices allow counterfeiters to breach pharmaceutical supply chain security. Also contributing to the introduction of black market fakes is diversion from lower to higher price markets and relabeling of expired but legitimately manufactured product, “3rd shift” manufacture, as does its theft, followed relabeling and reintroduction to the supply chain.

There is a particular need to expand the available technologies that may be used to deter diversion of drugs with abuse potential because of the health risks associated therewith. Diversion of drugs with abuse potential is related to the broader problem of counterfeit and gray market medicines because here too package-level security measures are inadequate. The US Department of Justice, Drug Enforcement Agency (DEA) has reported that abuse of prescription pharmaceuticals that are controlled substances has increased from 2001 through 2008. According to the 2007 National Survey on Drug Use and Health, an estimated 7% of adolescents and 5% of adults (roughly 13 million people, total), used prescription pain relievers for nonmedical reasons during the prior year. One in 10 high school seniors report abusing Vicodin® and 1 in 20 abuse OxyContin®. Thus, it is not surprising that fraudulent use of prescriptions contributes to these problems. According to DEA's “A Pharmacist's Guide to Prescription Fraud,” February 2000, Vol. 1, Issue 1, pharmacists should be aware of the various kinds of fraudulent prescriptions which may be presented for dispensing.

Among the routes to prescription fraud are where legitimate prescription pads are stolen from physicians' offices and prescriptions are written for fictitious patients and computers are often used to create prescriptions for nonexistent doctors or to copy legitimate doctors' prescriptions. Additionally the text and other human-readable contents of a legitimate prescription may be altered in order to obtain controlled substances for non-medical purposes, including being altered to obtain additional amounts of legitimately prescribed drugs. A prescription is an order for medication which is dispensed to or for an ultimate user. In the United States, a prescription for a controlled substance must be dated and signed in ink on the date when issued. The prescription must include the patient's full name and address, and the practitioner's full name, address, and DEA registration number. Among the other text and other human-readable contents that the prescription must include are drug name, strength, and quantity prescribed, among other things. All of this text and content is subject to change for fraudulent purposes.

Moreover, the prescriber's signature solely assures all the information on a prescription. More broadly, signatures encompass marks and actions of all sorts that are indicative of identity and intent. The legal rule is that unless a statute specifically prescribes a particular method of making a signature it may be made in any number of ways. These include by a mechanical or rubber stamp facsimile. A signature may be made by the purported signer. Alternatively someone else duly authorized by the signer acting in the signer's presence and at the signer's direction may make the signature. For example, the role of a signature in many consumer contracts is not solely to provide evidence of the identity of the contracting party, but rather to additionally provide evidence of deliberation and informed consent. This is why the signature often appears at the bottom or end of a document. The signature thus imparts value to any document bearing it.

The signature of a famous person is sometimes known as an autograph, and is then typically written on its own or with a brief note to the recipient. Rather than providing authentication for a document, the autograph is given as a souvenir that acknowledges the recipient's access to the person providing the autograph. Autographs are known to be valuable standing alone, and to increase the value of articles that bear them.

Signatures encompass marks and actions of all sorts that are indicative of identity and intent. Generally, unless a statute specifically prescribes a particular method of making a signature it may be made in any number of ways. These include by a mechanical or rubber stamp facsimile or even a digital image pasted into a document. Because of the value that signatures impart, methods have been developed to identify genuine signatures and distinguish them from forgeries and frauds.

More generally, the text and other human-readable contents of a document also may be altered for fraudulent purposes. Medical records may be altered to file fraudulent insurance claims or to support fraudulent prescription claims for obtaining controlled substances for non-medical purposes as described in more detail above. Academic records, such as transcripts, letter of recommendation, and diplomas may be altered or faked as a means to gain acceptance to higher education or to obtain employment by misrepresentation of qualifications. Specifically with transcripts, grades may be changed, sometimes using PHOTOSHOP or an equivalent to “replace” a grade with the image of a better one (an “A” for a “C”, for example). Additionally, commerce in counterfeit goods generally requires a fraudulent document for introduction of such goods in the legitimate supply chain; for this purpose, customs forms, shipping manifests and the like are all targets of fraudulent change, whether mechanically or digitally.

Solutions for automated authentication and identification of text in documents include for example, DOCU-PROOF ENTERPRISE from Global Vision USA. These solutions are generally limited to maintaining sensitive and valuable text, signatures and other human-readable contents in a database for comparison, leaving the comparator database, itself, open to theft and fraud, and thereby requiring costly measures to prevent the same.

Solutions for securing information in the digital realm are widespread. For example, Transport Layer Security (TLS) and Secure Sockets Layer (SSL) are methods used for securing information that is transmitted over the Internet, and digital watermarking involves embedded information in a digital signal that is used to verify its authenticity or the identity of its owners, typically used in conjunction with copyrighted material. A substantial limitation of such solutions is that it is difficult to make a link between the information that they secure in the digital realm with the manifestations of that information in the real world, for example, in print outs from computer systems and the like.

Overall, there is a continuing need to develop novel methods to combat counterfeiting of legitimately manufactured drugs and other products. There also is a growing need to deter the diversion and theft of prescription narcotic analgesic products and other controlled substances with abuse potential. Further, because a signature imparts value that may be fraudulently obtained, it is imperative that an individual instance of a signature can be identified versus all other instances of that signature. All of these methods of automated authentication and identification of sensitive and valuable text, signatures and other human-readable contents benefit if the comparator database, itself, is not readily subject to theft and fraud. The present invention provides for methods for creating product authentication code that also yield individual article identity, and hence address all of the above needs.

### SUMMARY OF THE INVENTION

The present invention provides methods, systems and apparatus for authenticating products and/or identifying individual instances of a product. More specifically, specific or individual instances of the product may be identified via the product's packaging. Alternatively, the product may be an individual's signature, whether said signature is manually, machine, or software generated. The product also may be documents like prescriptions for medications, medical records, supply chain documents like customs forms and manifests, and academic records like transcripts, letters of recommendation, and diplomas. Methods of the invention are easy to implement and can be covert, but are difficult to replicate, simulate, alter, or transpose, and resist tampering and inadvertent or intentional alteration.

Embodiments of the invention provide a method of authenticating and identifying a product, comprising the steps of a) assigning a first layer to a product; b) assigning a second layer to the product; c) analyzing the interaction of the first layer with the second layer; and d) identifying an individual instance of the product based on the interaction of the first layer and the second layer. An assigned layer can be an already-existing characteristic of the product or can be a characteristic added to the product.

In some embodiments, the method further comprises assigning at least a third layer to the product and identifying an individual instance of the product based on the interaction of any combination of the first layer, the second layer and the third layer.

Embodiments of the invention provide a method of authenticating and identifying a product, comprising the steps of a) assigning a first layer to a product as a product authentication code; b) recording information about the first layer and the product authentication code; c) analyzing the product to obtain a measured first layer; comparing the measured first layer with that which is expected based on the recorded information; and d) accepting the product as authenticated when the first layer matches that which is expected. In some embodiments, the invention further comprises identifying an individual instance of the authenticated product. In some embodiments, the authenticating and identifying occur simultaneously. In some embodiments, the authenticating and identifying occur independently and at different times.

In some embodiments, identifying an individual instance of the authenticated product comprises identifying a specific manifestation of the product authentication code associated with the individual instance of the authenticated product. In other embodiments, said product authentication code associated with the individual instance is linked to at least one element of a digital security system.

In some embodiments, identifying an individual instance of the authenticated product comprises a) assigning a second layer to the product; b) analyzing the interaction of the first layer with the second layer; and c) identifying the individual instance of the authenticated product based on the interaction of the first layer and the second layer. In some embodiments, the method further comprises a) assigning at least a third layer to the product and b) identifying the individual instance of the product based on the interaction of any combination of the first layer, the second layer and the at least third layer.

In some embodiments, a layer of the present invention is a frequency array comprising a population of entities. In some embodiments, a layer of the present invention is an item characteristic. Embodiments of the present invention provide a method of authenticating a product and identifying said product, comprising the steps of: a) associating a population of entities with the product, wherein the population comprises at least two distinct clusters of entities having detectable counts or relative counts of entities per cluster; b) assigning a frequency array of the population of entities to the product as a product authentication code, wherein the frequency array comprises information about the counts or relative counts of entities of at least two distinct clusters of entities within the population; c) recording information about the frequency array and the product authentication code; d) analyzing the product to obtain a measured frequency array of the population of entities associated with the product; comparing the measured frequency array with that which is expected based on the recorded information; e) accepting the product as authenticated when the measured frequency array matches that which is expected; and f) identifying an individual instance of the authenticated product.

In some embodiments, identifying the individual instance of the authenticated product comprises identifying a specific manifestation of the product authentication code associated with an individual instance of the authenticated product.

In some embodiments, identifying the individual instance of the authenticated product comprises analyzing the interaction of the frequency array with an item characteristic and identifying an individual instance of the authenticated product based on the interaction of the frequency array and the item characteristic.

In some other embodiments, identifying the product authentication code is done by comparison to a database that contains only the information in the layer comprising the product authentication code.

In at least some embodiments of the invention, the population of entities comprises a combination or plurality of printed symbols. In some embodiments, the population of entities comprises a combination or plurality of microparticles.

Embodiments of the invention provide a uniquely coded product comprising a product and a product authentication code wherein the product authentication code is encoded by a frequency array of a population of entities associated with the product, wherein the frequency array comprises information about the counts or relative counts of entities of at least two distinct clusters of entities within the population and wherein the product authentication code is used for item identification. In some embodiments, the product's item identification comprises identifying a specific manifestation of the product authentication code associated with the individual instance of the authenticated product. In some embodiments, the product's item identification comprises analyzing the interaction of the frequency array with an item characteristic and identifying the individual instance of the authenticated product based on the interaction of the frequency array and the item characteristic.

In at least some embodiments of the invention, the product is a pharmaceutical product or component thereof. In some embodiments, the product is a document, for example a document selected from the group of documents including prescriptions for a pharmaceutical products, medical records, supply chain documents like customs forms and manifests, and academic records like transcripts, letters of recommendation, and diplomas. The document can be in any form, for example a paper document or an electronic document. In some embodiments, the product is an individual's signature. In still other embodiments, the printed symbols or microparticles comprising the population of entities are found on the packaging or documents associated with the product.

### BRIEF DESCRIPTION OF THE DRAWINGS

Having thus described embodiments of the present invention in general terms, reference will now be made to the accompanying drawings, which are not necessarily drawn to scale, and wherein:

FIG. 1 shows a flow chart in accordance with embodiments of the present invention;

FIG. 2 shows an original (kernel) image and a resulting library of images in accordance with embodiments of the present invention;

FIG. 3 shows a digital encoded image in accordance with embodiments of the present invention;

FIG. 4 shows a scatter plot summarizing image segmentation analysis in accordance with embodiments of the present invention;

FIG. 5 shows a digital encoded image in accordance with embodiments of the present invention;

FIG. 6 shows a digital encoded image in accordance with embodiments of the present invention;

FIG. 7 shows a text code example in accordance with embodiments of the present invention; FIG. 8 shows a flow chart in accordance with embodiments of the present invention; FIG. 9 shows an example of product authentication and identification in accordance with embodiments of the present invention;

FIG. 10 shows an example of text printed on an encoded field in accordance with embodiments of the present invention;

FIG. 11 shows an example of text printed on an encoded field in accordance with embodiments of the present invention;

FIG. 12 shows an example of an academic transcript placed over an encoded field in accordance with embodiments of the present invention;

FIG. 13 shows a partially exploded view of an example of an academic transcript placed over an encoded field in accordance with embodiments of the present invention.

FIG. 14 shows a chart according to one or more embodiments.

### DETAILED DESCRIPTION OF THE INVENTION

All publications cited below are hereby incorporated by reference in their entirety. Unless defined otherwise, all technical and scientific terms used herein will have the commonly understood meaning to one of ordinary skill in the art to which this invention pertains.

It must be noted that as used herein and in the appended claims, the singular forms “a,” “an,” and “the” include plural reference unless the context clearly dictates otherwise. Thus, for example, a reference to “a population of entities” is a reference to one or more populations of entities and includes equivalents thereof known to those skilled in the art and so forth. .

As used herein, a “cluster of entities” or a “cluster” means a classification of at least two entities that are grouped together because they share one or more discretely measurable common properties. In particular embodiments of the invention, the entities within “a cluster of entities” share one, two, three, four, five, six, seven, eight, nine, ten, or more discretely measurable common properties.

As used herein, the “count of entities per cluster”, the “number of entities per cluster”, the “count (or number) of entities within a cluster”, and the “count (or number) of entities of a cluster” are used interchangeably to mean the number or sum total of entities within a cluster. The “count of entities per cluster” can be obtained by counting discrete entities within the cluster by means such as an automated counter or manual counting method.

As used herein, the term “counterfeit” when applied as a description to a product or drug means a product made in imitation of a genuine product or drug with intent to deceive. As used herein, the terms “counterfeit drug” and “counterfeit pharmaceutical product” may be used interchangeably. For example, a counterfeit drug is a composition that has not received approval by a governmental authority (e.g., the Food and Drug Administration of the United States) to be safe and efficacious for medical purpose in human subjects, but is labeled as a genuine pharmaceutical product. Another example of a counterfeit drug is a pharmaceutical composition that has been tampered, such as by dilution. A “counterfeit drug” also includes a composition that contains the same active ingredient(s) as that of a genuine pharmaceutical product, but is made by a party who is not legally entitled to do so, and that party passes off the composition as that of a genuine pharmaceutical product. A “counterfeit drug” as used herein also includes drug diversion or “grey market drug”. Drug diversion occurs when a counterfeiter acquires genuine, non-counterfeit drugs that are targeted for one market and sells them in a different market for a profit. The counterfeiter does this to circumvent the manufacturer's goal of controlling the supply of the drugs in a particular market. As a consequence, the counterfeiter benefits from the sales in that limited supply market or in the diverted sales market.

As used herein, the term “data item” means a single member of data.

As used herein, the term “data” means two or more individual facts or pieces of information.

As used herein, a “discretely measurable common property” is a property of or associated with each individual entity within a single cluster, and said property can be measured from the individual entity. The discretely measurable common property allows an entity to be assigned into a particular cluster. For example, for the discretely measurable properties of apparent size and relative fluorescence, entities having the same set of discretely measurable common properties can be assigned into the same cluster. Entities having different sets of discretely measurable common properties can be assigned into distinct clusters. Examples of “discretely measurable common property” include, but are not limited to, the properties of one or more tags associated with entities of a cluster, such as the fluorescent intensity or spectra when the entity is labeled with a fluorescent tag, the sizes of the entities, the shape of the entities, and other properties of the entities, such as being magnetic or not, density, or solid characterization, or the nucleotide sequence or amino acid sequence when the entities are composed of nucleic acid molecules or peptides/polypeptides.

As used herein, the term “frequency array” means the counts or relative counts of a collection of data items classified into distinct clusters of entities. It is understood by a person skilled in the art that there is a basic distinction between measurement and counting. The result of counting, for example, the count of entities within a cluster, is exact because it involves discrete entities that are not subdivided into fractions. The result of measurement, on the other hand, involves measurement units that may be subdivided into smaller and smaller fractions and is thus always an estimate. A good measurement should be both accurate and precise. Accuracy is determined by the care taken by the person making the measurement and the condition of the instrument; a worn or broken instrument or one carelessly used may give an inaccurate result. Precision, on the other hand, is determined by the design of the instrument; the finer the graduations on the instrument's scale and the greater the ease with which they can be read, the more precise the measurement. The choice of the instrument used should be appropriate to the desired precision of the results. A person skilled in the art knows how to choose an appropriate instrument for a particular measurement.

As used herein, “distinct clusters of entities” means clusters wherein entities within one cluster having at least one discretely measurable common property that is not shared with the entities within the other cluster(s). Thus clusters of entities can be distinguished from one and another by measuring any of the discretely measurable common properties shared by entities within one cluster but not by entities within the other cluster(s)—the distinct discretely measurable common properties. For example, characters in this line of text have discretely measurable common properties; an “m” is distinct from an “n” and from an “o”, etc. The clusters of entities of printed symbols also can be distinguished by size, intensity, color, font, etc. The clusters of entities can also be distinguished by shape. The shape of a printed dot, for example, can be measured by a scanner. The clusters of entities can further be distinguished by tags, such as by fluorescent dyes with different emission wavelengths. Even when they are labeled with the same tag(s), the clusters of entities can still be distinguished because of different concentrations, intensities, or amounts of the tag associated with the entities, or the different ratios of tags on individual entities. Clusters of entities can be distinguished even when all entities share one or more discretely measurable common properties (e.g., symbol size and symbol shape), but do not share at least one other discretely measurable common property (e.g., intensity or amount of fluorescent tag per entity). Methods known to a person skilled in the art can be used to measure the quality or quantity of tags. In addition, one of ordinary skill in the art understands that the clusters of entities can be differentiated by other property or characteristic of the entities.

In order to detect the count or relative count of entities within distinct clusters of a population, the clusters of entities must first be distinguished based on the measurement of the distinct discretely measurable common property or properties. It is readily apparent to a skilled artisan that the detection of the count or relative count of entities within distinct clusters of a population thus depends on the accuracy and precision of the measurement of the distinct discretely measurable common property or properties. If the distinct discretely measurable common property cannot be reproducibly measured, the clusters cannot be distinguished with confidence, thus the count or relative count of entities within distinct clusters cannot be detected. Therefore, a condition precedent to detecting count or relative count of entities within distinct clusters of a population is the reproducible measurement of the distinct discretely measurable common property. In the present invention, at least two distinct clusters of entities are mixed in a population wherein the clusters are distinguishable by one or more reproducibly measurable distinct discretely measurable common properties. Thus, the counts or relative counts of entities within the distinct clusters of the population of the present invention are detectable.

As used herein, the terms “drug” and “pharmaceutical product” may be used interchangeably. The terms mean a composition that has received approval by a governmental authority (e.g., the Food and Drug Administration of the United States) to be safe and efficacious for medical purpose in human subjects. The “drug” can be in any physical state, such as being solid, liquid, or semi-liquid. The “drug” can be in any form of formulation, such as being an oral, topical, injectable, or parental pharmaceutical product.

As used herein, the term “entity” means a thing or composition that can exist separately or independently from other things. Examples of entities that can be used in the present invention include, but are not limited to, printed symbols and particles of various sizes.

In some embodiments, the entities can be printed symbols. As used herein, the term “printed symbol” means any symbology that is placed on or otherwise applied to a surface of a material. The “printed symbol” can be in any form or shape. For example, it can be dots, letters, or other visible or invisible signs. The “printed symbol” can have different shapes, such as square, circle, triangle, diamond, or any other shapes that can be distinctively measured. The “printed symbol” can also have different fonts or sizes. For example, the dots can have a size of 0.05-1 μm, 1-20 μm, 50-100 μm, or 0.1-5 mm in diameter, width, or length in the case dots are not circular. The “printed symbol” can be any printable characters selected among many alternative identities, for example, symbols or Greek alphabet characters, the Roman alphabet characters, or any other characters of any language. Further, the font size and or style of “printed symbol” could be replaced with any number of alternatives, for example, font, color, italics, striking-through, highlighting, bolding, underlining, shadowing, outlining or the like. Whole words, images, or logos may replace individual characters to be used as “printed symbols”. The “printed symbol” can also be any symbols, such as those listed in Microsoft Word or any other signs.

The “printed symbol” can be placed on or applied to the surface of a material by a variety of means. For example, it can be applied to a printable surface by printing; or it can be applied to a surface by dropping, spraying, painting, rolling coating, embossing, debossing, engraving, etc. The ink used for printing may be visible or invisible to the unaided eye.

Additionally, microprinting is an alternative to the conventional printing used in this example. Microprinting is an anti-counterfeiting technique used most often on currency and bank checks, as well as various other items of value. Microprinting involves very small print, usually too small to read with the naked eye, onto the note or item. Microprint is frequently hidden in an inconspicuous, unnoticeable area on the note or item, but may be placed in a prominent location on the item, and may even be labeled with an “MP” symbol as a warning that the note or item contains microprinting. For example, U.S. Pat. No. 6,214,766 B1 relates generally to a method for producing security paper that involves printing microdot images using a colorless ink containing starch, such dots to be revealed by exposure to iodine.

In another embodiment, the entities are microparticles. As used herein, the terms “microparticle”, “microsphere”, “microbead”, “bead”, and “particle” are used interchangeably and bear equivalent meanings with respect to their particulate nature, understanding that particles can have various shapes and sizes. For example, particles can range in size from approximately 10 nm to about 200 μm in diameter or width and height in the case of nonspherical particles. In pharmaceutical applications, for example, the particles can have a size of 0.05-50 μm, 0.1-20 μm, 1-20 μm, or 3-10 μm in diameter. The microparticles can have a different shape, such as a sphere, cube, rod or pyramid. Other shapes are easily recognized by those of ordinary skill in the art as falling within the scope of the present invention.

Those of ordinary skill in the art can use microspheres of various compositions. For example, styrene monomer polymerized into hard rigid latex spheres has been used as a calibration aid at high magnifications. These latex spheres are known for their high level of inertness in the electron beam and clusters constructed from groups of such particles within non-overlapping size ranges of approximately 0.05 to 2 microns may be detected by electron microscopy or light-scattering investigations Likewise, the particles can be made of many other types of materials. For example, the microparticles can be made of polystyrene or latex material. Other types of acceptable polymeric microspheres include, but are not limited to, brominated polystyrene, polyacrylic acid, polyacrylonitrile, polyacrylamide, polyacrolein, polybutadiene, polydimethylsiloxane, polyisoprene, polyurethane, polyvinylacetate, polyvinylchloride, polyvinylpyridine, polyvinylbenzylchloride, polyvinyltoluene, polyvinylidene chloride, polydivinylbenzene, polymethylmethacrylate, POLYOX, EUDRAGIT, sugar spheres, hydrofuran, PLGA (poly(lactic coglycolic acid)) or combinations thereof. In general, such particles can be made by a copolymerization process wherein monomers, e.g., unsaturated aldehydes or acrylates, are allowed to polymerize in the presence of one or more tags, e.g., fluorescein isothiocynate (FITC), in the reaction mixture (see for example U.S. Pat. No. 4,267,234 issued to Rembaum; 4,267,235 Rembaum et al; 4,552,812, Margel et al.; and 4,677,138, Margel). The microparticles can be produced, for example, by extrusion or spherenization.

To increase the per volume information content, the entity can be labeled with one or more tags that are visible or invisible to naked eyes. The term “tag” or “taggant” as used herein can be any composition that is suitable for the purpose of detecting or identification. The tag can be overt, covert, or invisible or otherwise difficult to detect on individual entities or small numbers of entities, yet having an overt signal detectable from all or a larger number of entities. For example, the entity can be labeled with one or more colors, fluorescent dyes, ultraviolet radiation dyes, luminescent compositions, hapten, nucleotides, polypeptides, or scents. A single entity can be labeled with more than one tag of the same or different types. For example, a particle can be labeled with two or more discretely distinguishable dyes in varying proportion; or a particle can be labeled with a nucleotide and a fluorescent dye. Any known tags and combinations of tags with entities can be used in the invention. Methods known to those skilled in the art can be used to label an entity with one or more tag. For example, U.S. Pat. No. 6,632,526 teaches methods of dyeing or staining microspheres with at least two fluorescent dyes in such a manner that intra-sample variation of dye concentrations are substantially minimized. The entity can be a segmented particle whose composition is varied along the diameter or the length of the particle. U.S. Pat. No. 6,919,009 teaches methods of manufacture of rod-shaped particles.

In some embodiments, the entity can be an entity that is labeled with or affixed to other entities. For example, the entity can be a symbology printed with an ink containing microparticles. Another example of such entity is a particle that is covalently or non-covalently affixed with one or more other particles. US 20060054506 describes submicron-sized particles or labels that can be covalently or non-covalently affixed to entities of interest for the purpose of quantification, location, identification, tracking, and diagnosis.

As used herein, a “population of entities” or a “population” means a collection of a combination or plurality of entities that include two or more distinct clusters of entities, wherein entities within one cluster have one or more discretely measurable common properties that are different from that of entities within another cluster from the same population.

As used herein, the term “relative counts of entities per cluster” means a ratio of the count of entities per cluster relative to another number. In some embodiments, the other number is the count of entities within a different cluster. In other embodiments, the other number is the total count of entities within two or more clusters of a population of entities. In other embodiments, the other number is representative of the amount or concentration of the cluster or the population of entities, such as unit volume or weight of the cluster or the population of entities. In yet other embodiments, the other number is representative of the amount or concentration of a product the cluster is associated with, or the amount or concentration of a portion or a component of the product.

As used herein, the term “a representative number of entities within a population of entities” refers to a fraction or a portion of the population of entities which contains the same clusters of entities and the same count of entities per unit of each cluster as those of the population.

As used herein, “a frequency array of a population of entities” is an array comprising information about the counts or relative counts of entities of at least two distinct clusters of entities within the population.

The existence of a frequency array for a population of entities provides a method of authenticating a product, for example a pharmaceutical product, which is easy to operate, but difficult to imitate or counterfeit. The method of authentication uses a product authentication code defined by a frequency array of a population of entities, which has high per volume information content. A product is accepted as authenticated if the measured frequency array of the product matches that which is expected.

As used herein, a “product authentication code” is a system or code that represents information specific to a product. The system or code is matched with a product type or batch of product of a particular type such that tracking or sampling of the code associated with the particular product or batch of products provides those designated by the source to know any of a variety of characteristics or information about the product(s). For example, a “product authentication code” for a pharmaceutical product can represent information about the product, such as the chemical composition, the concentrations of the effective ingredients, the date or place of manufacture, the source of distribution, the batch, the shelf life, or a myriad of other information designations.

A “product authentication code” establishes a product's authenticity and provides a method for tracing product in the supply chain. A “product authentication code” also addresses re-importation issues, e.g., where a product like HIV drugs are sold outside the developed world under license conditions that preclude sale of licensed products back into the developed world. It can further be used in forensic toxicology to unequivocally identify use/misuse of a product and defend against baseless liability claims, etc.

It is readily appreciated that the present invention encompasses a vast number of product authentication codes depending on the number of clusters and the number of counts per cluster in the frequency array. That is, varying the quantity or quality of entities within a population of entities results in a different pattern of the frequency array, thus a different product authentication code.

In some embodiments, different product authentication codes can be obtained by varying the combination of clusters of entities within the population of entities. Different clusters having different discretely measurable common properties are useful in creating different populations of entities, thus different frequency arrays and different product authentication codes.

In other embodiments, different product authentication codes can be obtained by varying the counts of entities within clusters of the population of entities.

In yet other embodiments, different product authentication codes can be obtained by varying both the composition of clusters that form the population of entities and the counts of entities within one or more clusters.

It is readily appreciated the high per volume information content of the frequency array plus the myriad of codes that may be encoded by frequency array is very great, limited only by Poisson counting statistics.

In one embodiment, entities with two discretely measurable properties, P1 and P2, can be classified into M clusters, as follows: M=NP1×NP2, where N=number of discrete measurable levels for each property, P1 or P2. In general, the sum of all the combinations of unique product authentication codes that can be created, I, from a data matrix of M clusters is: I=2M−1, i.e., all possible combinations less the one instance where no cluster is represented in the array. In an illustrative embodiment, e.g., where NP1 and NP2 each=5, M=25 clusters of entities can be obtained. From the 25 clusters, there are I=225−1=33,554,431 (i.e., approximately 3×107) possible unique product authentication codes by simply varying the combinations of the clusters to form the population of entities.

In another embodiment, R discretely measurable properties, P1, P2, . . . , PR, can be combined to yield a data matrix or data array with M clusters, as follows, M=NP1×NP2×. . . xNPR, where N is as defined supra. Therefore, the sum of all the combinations of unique product authentication codes that can be created, I, from a data matrix of M clusters is I=2M−1. Thus, with R=3 measurable properties and NP1, NP2, and NP3 each equal to 5, M=125. Then, the number of possible unique product authentication codes is approximately 4×1037.

In another embodiment, certain cluster(s) may be reserved to identify specific attribute(s) of the product, while other clusters in the population may be used in combination to create codes identifying variable attributes of the product such as production lot number. In this case, the sum of all the combinations of unique lot codes that could be generated from a data matrix of M clusters is: I=2(M-K)−1, where K is the number of clusters always occupied or fixed for the product identifier. Thus, for a 25-cluster data array and where K is a set equal to 5, there are still 1,048,575 (i.e., approximately 1×106 or 1 million) possible unique lot identification codes.

In yet another embodiment, CLn/CRef, the ratio of count of entities within a cluster (CLn) relative to that within a reference cluster (CRef) or the absolute count of entities within a cluster, [CLn], is used as a measured parameter, PC. In the general case, PC expands the number of additional unique identifiers as follows: I=(NC+1)(M-K)−1, where NC=number of statistically-distinguishable discrete ratios per cluster or absolute count levels that may be measured practically corresponding to a cluster, and M and K are as defined supra. Thus, from 25 clusters of entities, and where K is a set equal to 5 as above, 3 discrete ratios or absolute count levels for N_{C} yields 1,099,511,627,775 (i.e., approximately 1×10¹² or 1 billion) possible unique lot identification codes.

In yet another embodiment, once the ratios for each cluster are specified, the total count of all entities per unit volume or unit weight of all clusters is used as a measured parameter, PTot. In the general case, PTot expands the number of additional unique identifiers as follows: I=NTot*((Nc+1)(M-K)−1), where NTot=number of statistically-distinguishable discrete total count levels per unit weight or unit volume that may be measured practically summed across all clusters in a population of entities. Thus, from 25 clusters, where K is a set equal to 5, and 3 discrete ratios or absolute count levels for NC exist, as above, if NTot has just 4 levels, more than 4 billion unique lot identification codes are possible.

In the foregoing embodiments, values selected for R, M, K, NC , and NTot are selected for purposes of illustration only, and are not meant to be limiting of the practical range of values that may be achieved for the corresponding parameters. One of ordinary skill in the art can easily envision the many different values that can be applied to the parameters of the invention. That said, these examples demonstrate that frequency arrays of a population of entities accommodate a large amount of information.

As used herein, an “item identifier” is a system that represents information specific to an individual instance of a product. The “item”, or individual “instance” of a product, is an individual item, individual article or anything else that can be defined as an individual occurrence of a product. Individual instances or items of a product are often similar or identical, as is often the case by design between articles within a manufacturing run (i.e., a batch or lot) of a product. The item or instance can be one occurrence of a packaged end product (such as a box or sleeve of skin patches, a bottle of pills, or a box of syringes) or can be a single unit (an individual skin patch or an individual pill). There is no generic limit as to how an item or instance can be defined, as the item or instance will vary based on what the product is and what information related to the product is of interest.

The present invention provides a way to encode a product item or instance with a unique item identifier (or identifying code), thereby enabling information related to the unique code to be gathered and stored. The unique item identifier thus provides a way to capture and record transactions in which the item identifier is involved and can provide, in some circumstances, evidence of a chain of custody for the item. For example, an item identifier can be a unique linear string or other distribution of entities within a frequency array applied to a product, wherein the design of the frequency array is such that no duplication is expected or extremely infrequent duplication is expected, in the latter case with an expected frequency beyond the realm of practical likelihood. The distribution of entities may be determined in one dimension along a line or in a sequence, in two dimensions in an area, or in three dimensions in a volume. Thus, the unique spatial arrangement of entities is useful as an item identifier.

Alternatively, a unique item identifier can exist in the form of non-spatial variability in individual entities or the entire set of entities associated with an item. The application of entities to a product is inherently imperfect. For example, one cannot ensure that for a code consisting of two elements A and B with a respective ratio of 3:1 that each item receives exactly three microparticles of type A for every one microparticle of type B. This case can also apply to printed stock encoded with microprint or other printed code that is later subdivided into items. In another example, one might determine the intensity distribution within a class of entities for a given item. This distribution may differ from another item by a small but measurable amount. This error analysis is another non-spatial tool useful for item-level identification.

As used herein, the term “layer” means a distinct encoding method or characteristic that can be used alone or in combination with other encoding methods or characteristics, irrespective of spatial association between the two encoding methods or characteristics. To give an example, a single layer might be a microparticle code distributed across the surface of an item. A second layer could be printed symbols over the microparticle-coated surface. As used herein, “assignment” of a layer refers to the determination of layer identity to be used or correlated with a product. When combined, two or more layers impart added security that is significantly greater than a single encoding method. One of ordinary skill in the art understands that any number of layers can be employed in the present invention.

In at least some embodiments, the first layer of the item identifier is a unique code represented in two dimensions. In some embodiments, the boundaries of the code must be defined as the key to the code. In other words, a user must know a specific frame of reference in which to look for the code. In at least some embodiments, an authentication code provides a first unique layer. In some embodiments, the first layer is duplicated so that identical versions of the first layer are used in creating the item identifier. In such cases, a unique item identifier is still obtained from the interaction of at least a second layer with the first layer.

In at least some embodiments, a layer is a characteristic of the item. In some embodiments, a characteristic of the item is assigned as the second layer. In some embodiments, the second layer is duplicated so that identical versions of the second layer are used in creating the item identifier. In such cases, a unique item identifier is obtained from the interaction of the second layer with the first layer. It is the interaction of the first unique layer of characteristics with the second layer that provides the item identifier.

In some embodiments, both the first layer and the second layer are duplicated. Such duplication is useful, for example, when multiple verified copies of an original product are desired.

All of the above examples also apply to products having more than two layers. In some embodiments, at least one unique layer interacts with at least one other layer to provide a unique item identifier. Thus, in some embodiments, at least a third layer is assigned to the product and an individual instance of the product is identifiable based on the interaction of some combination of the first layer, the second layer, and the at least third layer. Alternatively, in some embodiments, all layers are duplicated to provide individual instances of multiple verified copies of an original product. One of ordinary skill in the art can easily envision products comprising three, four, five, six, seven, eight, nine, ten, eleven, twelve, fifteen, twenty or more layers.

Embodiments of the invention provide a method of authenticating and identifying a product, comprising the steps of a) assigning a first layer to a product; b) assigning a second layer to the product; c) analyzing the interaction of the first layer with the second layer; and d) identifying an individual instance of the product based on the interaction of the first layer and the second layer. An assigned layer can be an already-existing characteristic of the product or can be a characteristic added to the product.

In some embodiments, the method further comprises assigning at least a third layer to the product and identifying an individual instance of the product based on the interaction of any combination of the first layer, the second layer and the third layer.

Embodiments of the invention provide a method of authenticating and identifying a product, comprising the steps of a) assigning a first layer to a product as a product authentication code; b) recording information about the first layer and the product authentication code; c) analyzing the product to obtain a measured first layer; comparing the measured first layer with that which is expected based on the recorded information; and d) accepting the product as authenticated when the first layer matches that which is expected. In some embodiments, the method further comprises identifying an individual instance of the authenticated product. In some embodiments, the authenticating and identifying occur simultaneously. In some embodiments, the authenticating and identifying occur independently and at different times.

In some embodiments, identifying an individual instance of the authenticated product comprises identifying a specific manifestation of the product authentication code associated with the individual instance of the authenticated product.

In some embodiments, identifying an individual instance of the authenticated product comprises a) assigning a second layer to the product; b) analyzing the interaction of the first layer with the second layer; and c) identifying the individual instance of the authenticated product based on the interaction of the first layer and the second layer. In some embodiments, the method further comprises a) assigning at least a third layer to the product and b) identifying the individual instance of the product based on the interaction of any combination of the first layer, the second layer and the at least third layer.

In some embodiments, an item identifier comprises a specific manifestation of a layer. In some embodiments, an item identifier comprises the combination, or union in set theory, of a first layer with a second layer to provide a unique code for identifying the item. In embodiments in which the first layer is an authentication code, a user has the option to decipher only the authentication code of the item, the user can decipher only the item identifier, or the user can decipher both the authentication code and the item identifier. In some embodiments, the first layer is a frequency array. As described herein, the frequency array comprises a population of entities. In some embodiments, the second layer is an item characteristic. Any number of item characteristics can be used in the present invention.

One general aspect of the invention is a system that comprises information related to product authentication. Information related to a product authentication and an item identifier can be recorded, preferably stored in a database, and more preferably in a secured computer database. Information related to frequency array can include, for example, the composition of the population of entities used to mark the product for authentication, the discretely measurable common properties of the distinct clusters of entities used to generate the frequency array encoding the product authentication code, and optionally, the expected count or relative count of entities within each of the distinct clusters, etc.

Information related to a product authentication code can include the information represented by the product authentication code, such as the chemical composition, the concentrations of the effective or active ingredients, the date or place of manufacture, the source of distribution, the batch number, or the shelf life, etc. Information related to the product authentication code can also include information regarding the two dimensional format of the product authentication code. In some embodiments, information related to the two dimensional format of the product authentication code can include images and analyses of images.

Information linked to an item is one of two forms, either data related to the manufactured product itself, or authentication data used in the identification and authentication of the item. In the first case, data may pertain to the individual item at the time of production, such as where it was produced in the manufacturing line (for example, the item could have been produced as the fifth item in a group of ten). In the second case, information related to the item identifier can include all of the information related to the product as discussed for the product authentication code above. Further information regarding how the second identifying characteristic of the item identifier interacts with the first unique layer of the item identifier can be captured and recorded. Such information can include how the second identifying characteristic interacts with, affects, or combines with, the first unique layer. Such information may be made readily retrievable, for example, by means of a computer operation. In one embodiment, the system that comprises information related to product authentication is a computer. In some embodiments, the product authentication code is linked to at least one element of a digital security system.

Another general aspect of the invention is a method of marking a product for product authentication, comprising the steps of: a) associating a population of entities with the product, wherein the population comprises at least two distinct clusters of entities having detectable counts or relative counts of entities per cluster; and b) assigning a frequency array of the population of entities to the product as a product authentication code, wherein the frequency array comprises information about the counts or relative counts of entities of at least two distinct clusters of entities within the population. In some embodiments, the marking of a product for product authentication serves to create a first unique layer to be used with a second layer or identifying characteristic of the item to form an item identifier.

In a particular embodiment, the method of marking a product for product authentication further comprises a step of correlating the count or relative count of entities within one or more clusters of the population with a specific piece of information about the product, such as the amount, concentration, or presence or absence of a product component.

A wide range of entities is suitable for the present invention, so long as they are compatible with or non-deleterious to the product being marked. Examples of entities that can be used in the present invention, such as microparticles, printed dots, nucleic acids molecules, or peptides/polypeptides, etc. are described supra.

Examples of solid products include pharmaceuticals in tablets, capsules and powders; solid formulations of agrochemicals such as, but not limited to, insecticides, herbicides, fungicides and fertilizers; textiles and leather goods such as clothing, furnishings and accessories; recordings such as audio and visual recordings including gramophone records, tape cassettes, floppy discs, video cassettes, memory cards and compact discs; electrical goods such as television sets, computers, DVD players, portable music devices, and radios; motor vehicle components and cameras; paper such as documents, confidential papers, notes, securities, labels, and packaging; chemical products such as inks, biocides, and rubbers; cosmetics such as creams; and food products.

In one embodiment of the invention, the marked product is a pharmaceutical product. The marking of a pharmaceutical product with a product authentication code of the invention can be useful to notify the user, dispenser and/or law enforcement personnel of the composition of the pharmaceutical product enabling the notified parties to determine if the product being tested is the genuine pharmaceutical product from the correct source in the correct concentration. In some embodiments, the pharmaceutical product is marked for item identification by adding a second identifying characteristic to interact with the population of entities.

It will be appreciated that the population of entities can be associated with the product in a wide variety of ways. The population of entities can be present in or on all or part of the product, or in or on all or part of a label, wrapper or container associated with the product. The entities can be incorporated directly into the target product using any suitable technique.

In the case of a drug or chemically active agent, the entities can be formulated as is known in the relevant art to which the product relates. The entities can be incorporated into a pharmaceutical formulation during the tableting, granulation, spheronization, coating, encapsulation process, or in a combination of any of the aforementioned processes, and the like. For example, the entities can be incorporated in capsule contents (enteric use) or co-formulated in tablet (any enteric). Entities can also be incorporated in the delivery layer of a patch, for example, a transdermal patch.

In some embodiments when the entities are included in the pharmaceutical formulation, the entities are in the pharmaceutical formulation in an amount of below about 0.1% (by weight) of the final formulation. For example, where the entities are a population of microparticles, the microparticles can be included in an amount less than 100 ppm, less than 50 ppm, less than 25 ppm, less than 10 ppm or less than 5 ppm of the final formulation.

In some embodiments where possible and where the entities are added to a pharmaceutical formulation which has already been approved by a governmental agency that regulates pharmaceuticals (such as, for example, the Food and Drug Administration of the United States of America), the entities are included in an amount (e.g., such as an allowable impurity amount) which would not require a re-filing with, or re-approval by, the governmental agency of the pharmaceutical product that has been reformulated to include the heterogeneous population of microparticles. Preferably, the amount of the entities added to the pharmaceutical composition is below the impurity level as provided by the International Conference on Harmonisation (ICH) guidelines.

In other embodiments when the entities are included in the pharmaceutical formulation, the entities are ingestible and/or non-toxic in amounts used.

In certain further embodiments, the entities can be associated with the product by being present in or on the product container, packaging or labeling, or a combination thereof. For example, the population of entities can be applied to the inner, outer, or both inner and outer portions of a container for the pharmaceutical product. The entities can be incorporated into the container during the manufacturing process of the container, and/or the entities can be applied to the inner and/or outer portions of the container or alternatively added during fill. According to this embodiment, the container can take any appropriate form.

In specific embodiments, the entities are included in a label or an article that can be affixed to the container containing the pharmaceutical formulation. For example, where the entities are microparticles, inks containing the microparticles can be used to print the labeling directly onto the container, or printed dots can be printed directly onto the container. Alternatively, printed dots or inks containing the microparticles can be used to print the product authentication code onto a printable article or medium, which can be subsequently applied on a variety of interior and exterior surfaces of the product or the container of the product. In some embodiments, the printable article is adhesive. Inks, printable articles or media and methods to print microparticles onto a printable article or medium are known to those skilled in the art, see for example, Pat. No. 5,450,190.

The invention also includes an article that can be affixed to a product, wherein the article comprises a product authentication code of the invention.

In yet other embodiments, the entities can be microencapsulated into a layer of microcapsules, and then applied to the container containing a pharmaceutical formulation. During microencapsulation, very thin coatings of inert natural or synthetic polymeric materials are deposited around the entities to form a layer of microcapsules. The coating material can be chosen from a number of natural and synthetic polymers that is non-reactive with the entities, and is preferably nontoxic. Other components such as, for example, surfactants and plasticizers, may also be added to microcapsules.

The entities can also be affixed on an integrated surface of a pharmaceutical product. For example, the entities can be printed or co-formulated into capsule material (any enteric); co-formulated in the coating of a tablet (e.g., an enteric coating); incorporated into the marking on pre-filled syringes (for injection); or printing on the outer layer of a patch (for a transdermal).

The product authentication code of the invention can be used in combination with one or more other means for product authentication. For example, it can be combined with a radio frequency identification (RFID) tag, spectroscopic inks, hologram, reflective paper, laser etched paper, or a bar code on the on the package, container or label of the product. It can also be combined with a molecular marker or surface/formulated dye incorporated into the product.

Another general aspect of the invention relates to a product for sale in commerce, wherein the finished product comprises a product authentication code defined by a frequency array of a population of entities associated with the product, wherein the frequency array comprises information about the counts or relative counts of entities of at least two distinct clusters of entities within the population. The product authentication code serves as the first unique layer in creating an item identifier. A second item feature can serve to interact with the product authentication code to produce an item identifier. In one embodiment, the product is a pharmaceutical product. In some embodiments, the pharmaceutical product item is a pill, a bottle containing medicine, or a transdermal patch.

Another general aspect of the invention relates to a product that is a document subject to authentication and identification of text and other human-readable content in documents including signatures, wherein the finished product comprises a product authentication code defined by a frequency array of a population of entities associated with the product, wherein the frequency array comprises information about the counts or relative counts of entities of at least two distinct clusters of entities within the population. In some embodiments, a frequency array printed on the document as a background layer serves as the first unique layer in creating an item identifier. When the document is signed, the recorded signature can serve as second item characteristic, or layer, interacting with the product authentication code to produce an item identifier. The item identifier is formed from the interaction or union of the signature with the pattern created by the frequency array.

Embodiments of the product authentication code can be any pattern or other layer applied to the document. In some embodiments, the pattern is an ordered pattern. In other embodiments, the pattern is a randomized pattern. Generally speaking, a randomized pattern makes the product authentication code more difficult to replicate, simulate, alter, transpose, or tamper with. In some embodiments, the document starting material such as document paper or a template can be purchased with one or more layers already applied or in existence. One or more layers can additionally be applied to the paper, for example to create an item identifier.

Another general aspect of the invention is a method of determining a frequency array of a population of entities, comprising the steps of: a) classifying entities within the population into at least two distinct clusters of entities; b) determining the counts or relative counts of entities within each of the at least two distinct clusters; and c) combining the information about the counts or relative counts of entities of the at least two distinct clusters in an array. The population of entities can be associated with a product or exist separately from the product. When the population of entities is associated with the product, it can be either incorporated into the product or associated with the package, container or label of the product. In some embodiments, the frequency array serves as a first layer in authenticating the product and/or creating an item identifier for the product.

In some embodiments, the frequency array serves as a unique first layer in creating an item identifier. In some embodiments, the frequency array serves as a first layer that is identical in all instances of an item. An item characteristic can serve as a second layer to interact with the frequency array to produce an item identifier. If the frequency array is a unique first layer in each instance of an item, an identical item characteristic can be used for all items in a group, lot or batch, as the interaction of the frequency array and the item characteristic will provide a unique item identifier. If the frequency array is identical in all instances of an item, a second layer can be used to provide a unique item characteristic useful as an item identifier as the interaction of the frequency array and the item characteristic will still provide a unique item identifier

Depending on the pre-definition or the coding information for the frequency array, the array can be detected by measuring the one or more discretely measurable properties of each and all entities within the population of entities, a representative number of entities within the population, or a specific set of one or more clusters of entities within the population.

In some embodiments, the method of the invention further comprises a step of collecting some or all of the population of entities, such as the microparticles. In one embodiment, when the microparticles are associated with the label or container of the product, the microparticles can be collected by many standard techniques. For example, they can be rinsed off the container or label. In the case where the microparticles are microencapsulated into a layer of microcapsules, the layer of microcapsules can be peeled off from the label or container and dissolved or reconstituted, if necessary, to release the encapsulated microparticles.

In some embodiments, multiple discretely measurable properties of the entities within a population can be measured by a single measurement. For example, the discretely measurable properties of each microparticle within the population, such as the intensity of a dye, including a fluorescent dye associated with the particle, the number of particles, or the size of particles, can be obtained from a single flow cytometry measurement of the population of heterogeneous microparticles. The measured properties can then be plotted using readily available computer software programs.

The simultaneous measurement of two or more discretely measurable properties of the entities can be used when there is a concern that other components present in the environment of the entities may interfere with the specific measurement of the discretely measurable properties of the entities. For example, where flow cytometry is used, the normal range (2-200 μm) of formulation components of a drug may interfere with the laser light scattering particle size analysis of the particles that form a product identification code incorporated into the drug. However when the measurement is set to detect the size of particles having a certain fluorescent tag, the interference from the formulation components is minimized because the formulation components lack the fluorescent tag and will not be measured.

Those of ordinary skill in the art will recognize that populations of heterogeneous entities can be labeled with tags that can be measured with acceptable levels of interference from product formulation components, that can be separated from interfering product components by convenient means, or that have a combination of the foregoing properties.

The discretely measurable properties of the entities can be measured by methods known to those skilled in the art. For example, an image of a labeled item can record many optical properties of the entities. These optical properties include size, shape, texture, color, intensity, and orientation. Additional properties can be inferred from the optical properties of entities, such as mass, density, centroid, chemical composition, and chemical reactivity, among many others. Other properties measurable using non-optical sensors include radioactivity, thermal emission, conductivity, magnetic susceptibility, etc. For those skilled in the art, property measurement is achieved by using an appropriate sensor type with the appropriately scaled sensitivity and dynamic range tailored to the properties to be measured.

One aspect of the present invention is a method of authenticating and identifying a product, comprising the steps of: a) associating a population of entities with the product, wherein the population comprises at least two distinct clusters of entities having detectable counts or relative counts of entities per cluster; b) assigning a frequency array of the population of entities to the product as a product authentication code, wherein the frequency array comprises information about the counts or relative counts of entities of at least two distinct clusters of entities within the population; wherein information about the frequency array and the product authentication code is recorded; c) analyzing the spatial distribution of entities in the frequency array with an item characteristic; and d) identifying an individual item of said authenticated product based upon the said distribution.

Another aspect of the present invention is a method of authenticating and identifying a product, comprising the steps of: a) associating a population of entities with the product, wherein the population comprises at least two distinct clusters of entities having detectable counts or relative counts of entities per cluster; b) assigning a frequency array of the population of entities to the product as a product authentication code, wherein the frequency array comprises information about the counts or relative counts of entities of at least two distinct clusters of entities within the population; wherein information about the frequency array and the product authentication code is recorded; c) analyzing the interaction of the frequency array with an item characteristic; and d) identifying an individual item of said authenticated product based on the interaction between the frequency array and the item characteristic.

The authentication method of the present invention begins with marking a product with a product authentication code of the present invention. The information associated with the product authentication code and the information about the particular frequency array that encodes the product identification code is recorded. Based on the recorded information, an authorized person would expect to find a certain frequency array based on certain product information, or certain product information based on the detection of a certain frequency array associated with the product. To confirm whether a product in commerce is authentic, an authorized person, based on knowledge from the record, will readily know what particular frequency array is expected to be detected from the product. After determining the frequency array associated with the product using methods described supra, the authorized person will compare the measured frequency array with what is expected based on the recorded information. A match of the measured frequency array with that which is expected, taking into account the experimental errors of the measurements, indicates that the product in commerce is authentic.

The experimental errors of the measurement can result in uncertainty about whether the measured frequency array indeed matches that which is expected. To increase the level of confidence, multiple frequency arrays may be associated with a single product at different portions of the product to allow multiple measurements and comparisons of the measured frequency arrays with that which is expected. The multiple frequency arrays can be identical or distinct.

In some embodiments, the authentication code of the present invention is created in such a way that differences in the specific manifestation of the code between individual instances of a product occur while the measured and expected characteristics of the frequency array are preserved. The differences in the specific manifestation of the code provide a unique identifier for an individual instance of the product. Thus, in some embodiments, the method of identifying a product item includes recording the specifics of the frequency array to deduce the identification code of the individual instance of the product. The specifics noted can include position, layout, sequence, or other two- or three-dimensional aspects of the population of entities making up the frequency array of the authentication code as it is manifested in the individual instance of the product item.

In some embodiments articles, items or individual instances of a product each labeled with a frequency array will each have a unique pattern or code of the manifestation of the frequency array on the product. Therefore, with one application, a single product authentication code can be used to authenticate a group of individual instances of a product at, for example, the batch level or lot level, and the unique arrangement of cluster entities can be used to identify items at the unit, or individual instance, level. An item can therefore either be authenticated, identified, or both authenticated and identified, according to aspects of the present invention.

This invention will be better understood by reference to the examples that follow. Those skilled in the art will readily appreciate that these examples are only illustrative of the invention and not limiting.

### EXAMPLE 1

### Item Authentication and Identification Using Printed Image

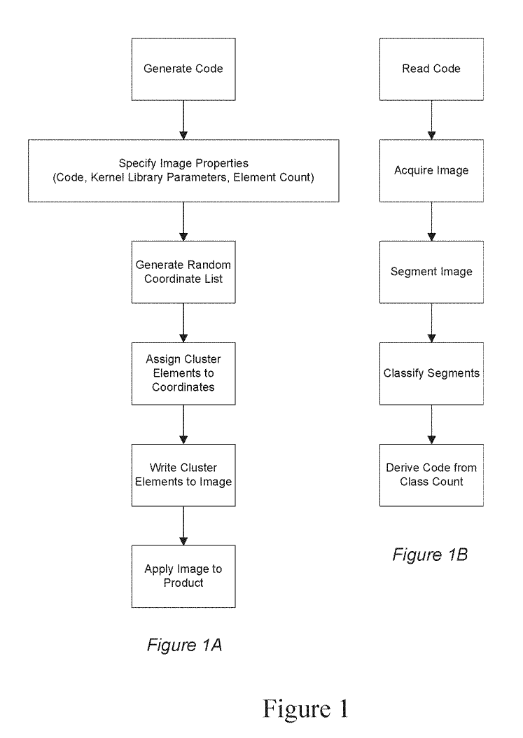

In the present Example, multiple sets of distinct symbols comprise populations of entities. These symbols were generated and selected for printing using high-level matrix-based programming software (MATLAB) and an inkjet printer in order to simulate a method for printing onto adhesive-backed paper labels. FIG. 1 summarizes the algorithm used to generate an encoded image (FIG. 1A) and to subsequently “read” or analyze that image (FIG. 1B).

A single symbol served as a “kernel image,” a digital image the properties of which can be manipulated to change its appearance in measurable ways. The kernel image is comprised of pixels of uniform size and varying intensity. The kernel image was manipulated by altering its size dimensions and/or intensities on a pixel-by-pixel basis to generate a set of images, each image similar to the kernel image, but each having distinctly different measurable properties. Table 1 shows the kernel image, a white circle on a transparent background. A black outline was added to the kernel image to define the border between the white and transparent pixels in printed form. To create a library of cluster elements, the kernel image was scaled in brightness according to one of three different indexed intensities (95%, 75%, and 25% percent intensity). A 100% intensity level is represented by a white pixel, 0% intensity is a black pixel, and intensities between 0% and 100% are varying levels of gray. Each intensity-scaled image from the Intensity column was then scaled to match one of three indexed distinguishable diameters (50, 40, and 30 A.U.) to create 9 (3×3) distinct cluster elements that can be used to create populations of printed symbols for product authentication.

TABLE 1
Indexing of the kernel image, the 3 distinguishable
intensities, and the 3 distinct diameters.

| Image | | Intensity | | Diameter | |
|---|---|---|---|---|---|
| Index | Image | Index | % | Index | Diam (A.U.) |
| 1 | [symbol] | 1 | 95 | 1 | 50 |
| | | 2 | 75 | 2 | 40 |
| | | 3 | 25 | 3 | 30 |

Using a MATLAB algorithm, the kernel image and user input are combined to generate an encoded image. The algorithm accepts a kernel image as input, and performs geometric operations on that image to generate the output: an array of cluster elements that are distinctly different. The algorithm then spatially arranges multiple copies of cluster elements randomly in the encoded image but at a relative frequency of elements by type according to a user-specified product authentication code. One of ordinary skill in the art recognizes that since the arrangement of entities is randomized, each execution of the algorithm yields a unique encoded image. Such a unique image results in a memorialization of each execution, or “instance” of recreating the same product authentication code. Moreover, it is apparent to one of ordinary skill in the art that when entities are rendered as symbols as in this Example 1, relatively short strings of symbols or small areas of symbols provide item identification information.

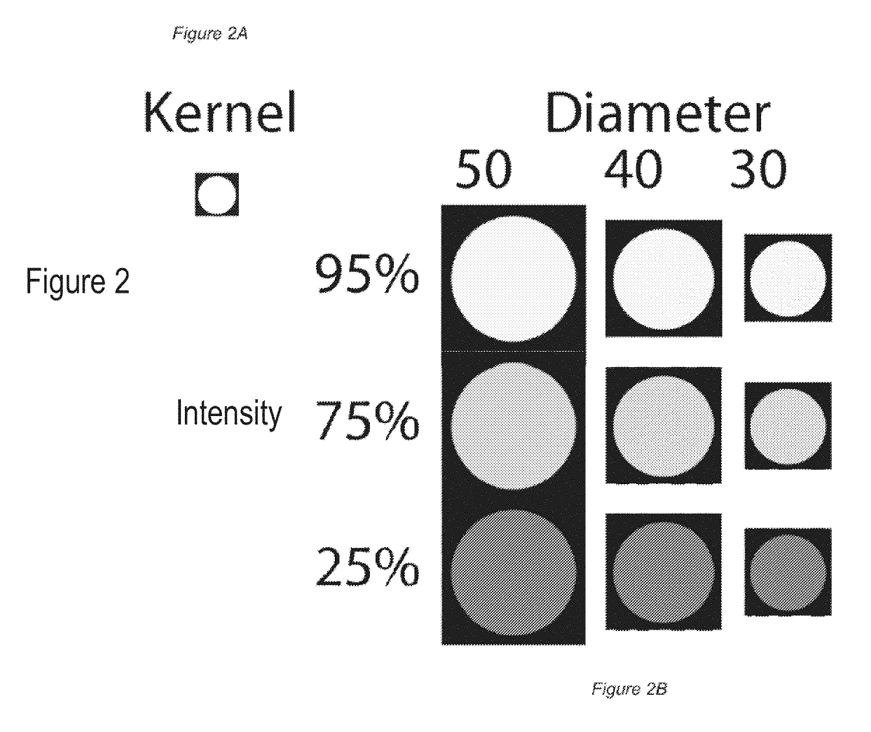

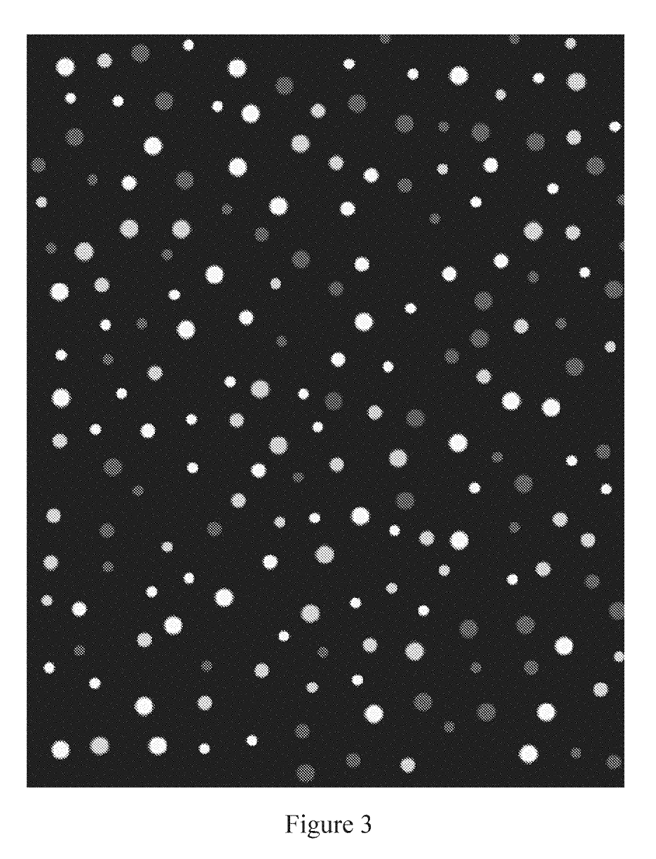

At a more detailed level, the kernel image is manipulated first to generate a set of cluster elements as pictured in FIG. 2. The kernel image is pictured at FIG. 2A and the nine array members are pictured at FIG. 2B. This library of images is stored as a reference table.

Each cluster element in the reference table was assigned a cluster reference letter (A-I), as indicated in Table 2. A cluster reference letter refers to the cluster element with the corresponding diameter and intensity values, as depicted in FIG. 2B.

TABLE 2
Cluster reference letters identifying elements
according to diameter and intensity.

| | Diameter (A.U.) | | |
|---|---|---|---|
| Intensity | 50 | 40 | 30 |
| 95% | A | B | C |
| 75% | D | E | F |
| 25% | G | H | I |

Processing User-Specified Input

A user-specified product authentication code was stored in an array. In this Example, the code consisted of positive integers only, one integer per array element (nine integers in total) but no other restrictions were made on the code. The choice of nine integers in this Example is arbitrary, and the number of code elements is limited only by the number of kernel images that can be created and analyzed in uniquely identifiable groups. An exemplary code is shown in Table 3. Also, in this Example the user has specified a total element count (N); the total element count could be any positive integer greater than the number of elements in the array (N>9, in this instance). The total element count is defined as the total number of cluster elements present in the encoded output image. The code is defined as the relative count of each cluster element present in an encoded image. When each element in the encoded image is classified into one cluster category, the sum total of elements in each array indicates the scaled code. Finding the lowest common denominator of all the counts and expressing each array element total in terms of its relative frequency reveals a code that can be expressed as integers.

TABLE 3
Integer code indicating the relative count of cluster
elements according to diameter and intensity.

| | Diameter (A.U.) | | |
|---|---|---|---|
| Intensity | 50 | 40 | 30 |
| 95% | 2 | 1 | 3 |
| 75% | 1 | 2 | 1 |
| 25% | 2 | 1 | 2 |

To determine the total count of each cluster element (N_{A}, N_{B}, . . . Nₓ, where X is the total number of array elements) that is to be contained within the encoded image, the code is summed. The dividend, excluding any remainder, of N and the code sum is assigned to N_{adj}. Next, N_{adj} random coordinates are generated. An (N_{adj}×1) array is generated that contains the cluster reference letters for each coordinate pair. The first N_{A} elements in the array are assigned to cluster element A, the next N_{B} elements are assigned to cluster element B, and so on according to the N_{X} values. The random coordinates are assigned to a single element in the cluster reference array.

Image Generation

The digital image was created by first generating an (m×n) array of zeros, where the dimensions (in pixels) of the output image were m by n. Regions of zeros in the digital image array were overwritten according to the following scheme. The cluster elements were written to regions in the digital image array according to a coordinate pair (1<x<m, 1<y<n) and a corresponding cluster reference letter (cluster element to be written). An example of coordinate pairs and corresponding cluster reference letter for a 1024×1280 pixel image is shown below:

Coordinate=[(345, 900), (410, 675) . . . ]

Cluster reference=[G, B, . . . ]

In this way, N_{adj} cluster elements were successively written to locations within the digital image. This revised image array was saved as a digital image file. This digital image can then be printed on any surface compatible with the printing technology used. In this example the image was printed onto adhesive labels, which served as a comparable surrogate for a transdermal drug-delivery patch. FIG. 3 is a sample digital image rendered using the code described in Table 3. In this example (N=200) the coordinates were restricted so that no cluster element images overlapped. One of ordinary skill in the art recognizes that this is not a requirement, but prohibiting image overlap makes image segmentation and analysis simpler and less prone to error.

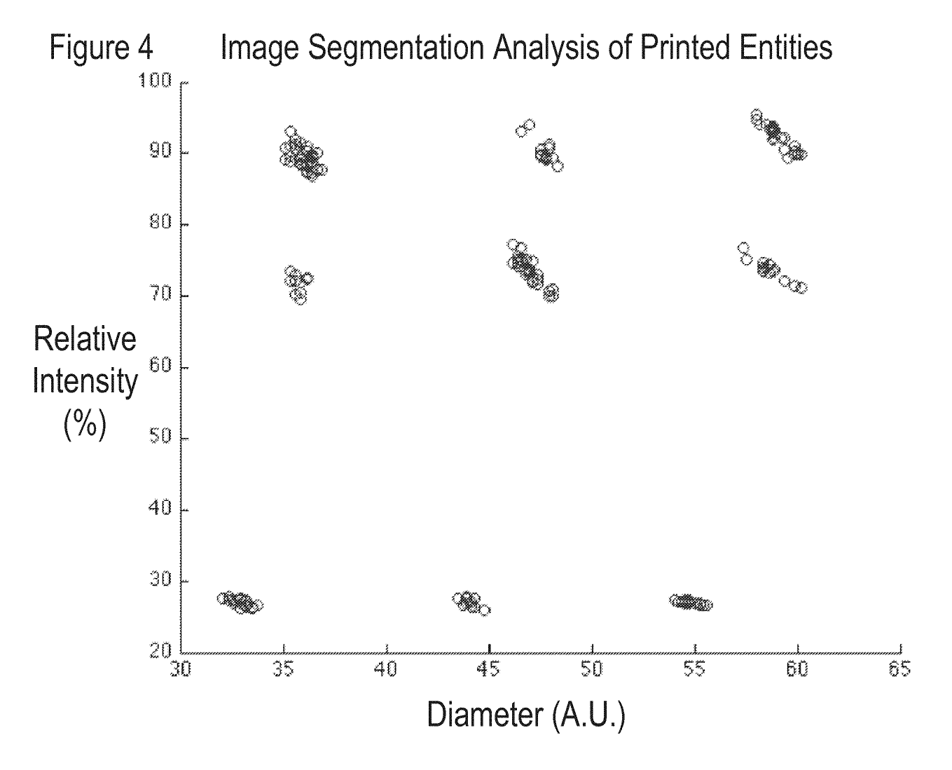

A custom-written MATLAB script performed image segmentation and analysis, and a summary of the distribution of particle diameter and intensity is pictured in FIG. 4. Cluster analysis of the particle property distribution reveals the integer code. The analysis steps undertaken by the custom-written MATLAB script were as described hereinabove. One of ordinary skill of the art recognizes that any script or method performing the steps laid out herein falls within the scope of the present invention.

One of ordinary skill in the art recognizes that no duplicate image or subset of an image is expected in replicate frequency arrays generated by the method of this Example. Thus, although it is not a requirement to practice the present invention, articles each labeled with a frequency array constructed as demonstrated in this example will each have a unique pixel pattern. In one application, a single integer code can be used to identify products at the batch level, and the unique arrangement of cluster entities can be used to identify items at the unit level. In contrast, identical copies of a signature image (i.e. duplicates that match pixel-for-pixel) will have both an identical code and identical unique identifiers, indicating the likelihood of forgery or counterfeiting.

Those of ordinary skill in the art of the present invention recognize that the clusters of printable symbols of the present invention are not limited to the representative images shown in FIG. 2. The kernel image can be any digital image, for example an individual's face or a corporate logo. The image may be rendered in color or gray scale, or even black and white. Color or gray scale may be a measurable property of an entity or fixed by position on the article, such that the frequency array information appears as part of a design, for example. The inks used to print the output image can be visible or invisible, and they can contain covert contents that carry additional encoded information. Similarly, the digital image can take on the overt appearance of a larger pattern, such as a logo or other aesthetically pleasing or otherwise visibly functional form. This application is discussed in the next example. Additionally, it is apparent that a variety of distinct clusters, by no means limited to the 9 clusters illustrated in Table 2, can be constructed from combinations of the aforementioned discretely measurable common properties for the printed symbols.

One of ordinary skill in the art recognizes that the product authentication code can be any pattern or other layer applied to a document. In some embodiments, the pattern is an ordered pattern. In other embodiments, the pattern is a randomized pattern. In some embodiments, the document starting material such as document paper or a template can be purchased with one or more layers already applied or in existence. One or more layers can additionally be applied to the paper, for example to create an item identifier.

One of ordinary skill in the art recognizes that printing entities of the present invention is not limited to adhesive labels or the backing layer of a transdermal patch. A variety of other suitable surfaces for printing entities can be found on product packages, including but not limited to shrink wrap, containers (such as vials or prepackaged syringes), and on medical devices (such as in the coating of stents or on the casing of implantable defibrillators). The entities may also form a security feature on paper, such as on a prescription pad, or form a seal, as often accompanies a signature on documents. It is further noted that one of ordinary skill in the art recognizes that the product authentication code can be linked to at least one element of a digital security system.

### EXAMPLE 2

### Item Authentication and Identification Using Printed Symbols that Form a Pattern

In the present Example, entities were comprised of sets of distinct populations of symbols generated and selected for printing using high-level matrix-based programming software (MATLAB) and an inkjet printer, as described in more detail in Example 1 herein. The digital image output contained an overt symbol that is representative of a logo or other shape that can convey information in addition to the product authentication code of the frequency array.

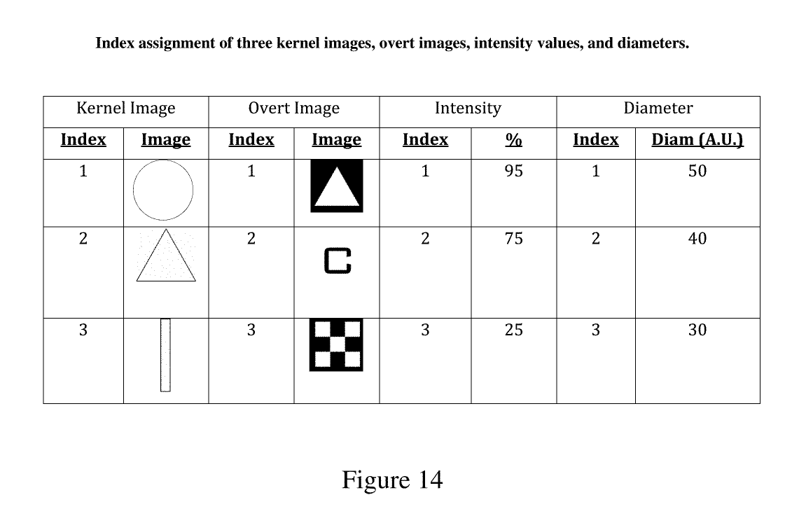

As described in Example 1, the kernel image was manipulated to generate a library of cluster elements. The coordinate pairs were randomly selected from a predetermined subset of pixels in the image array, as defined by the white regions in the images listed in the “Overt Image” column in FIG. 14. These elements were then written to an m x n zero-filled array to generate an encoded image with entities positioned in regions that form a pattern.

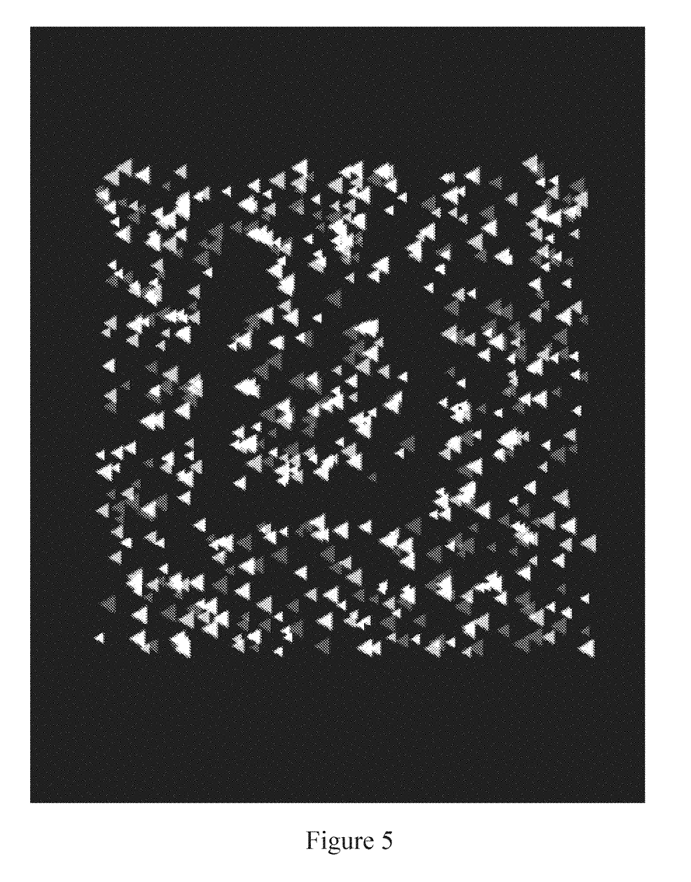

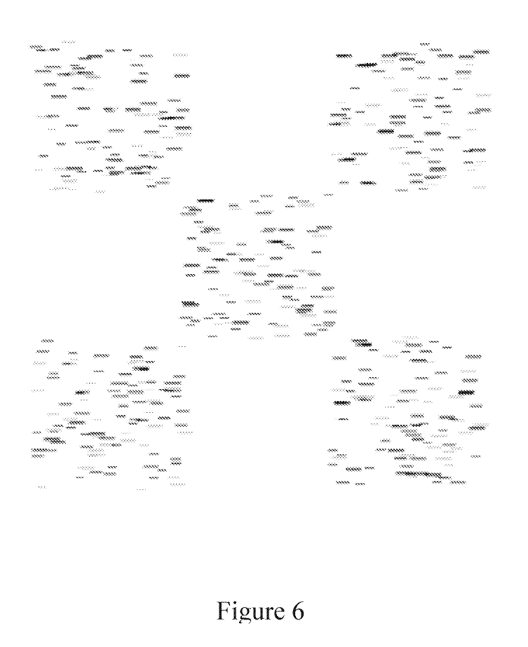

The sample code listed in FIG. 14 was used to generate images composed of triangular entities arranged in the shape of a character (overt image #2) and rectangular entities were randomly assigned to a boxed pattern (overt image #3); the digital images generated are pictured in FIG. 5 and FIG. 6, respectively. The images in FIG. 5 and FIG. 6 were generated using the same code that appears in FIG. 14.

One of ordinary skill in the art recognizes that the product authentication code can be any pattern or other layer applied to a document. In some embodiments, the pattern is an ordered pattern. In other embodiments, the pattern is a randomized pattern. In some embodiments, the document starting material such as document paper or a template can be purchased with one or more layers already applied or in existence. One or more layers can additionally be applied to the paper, for example to create an item identifier.

One of ordinary skill in the art recognizes that since the arrangement of entities generated in this Example 2 is randomized according to the method described in Example 1, each execution of the algorithm yields a unique encoded image. Such a unique image results in a memorialization of each execution, or “instance” of recreating the same code. Moreover, it is apparent to one of ordinary skill in the art that when entities are rendered as symbols to form a pattern as in this Example 2, relatively short strings of symbols or small areas of symbols in the pattern space provide item identification information. It is further noted that one of ordinary skill in the art recognizes that the product authentication code can be linked to at least one element of a digital security system.

### EXAMPLE 3

### Item Authentication and Identification Using a Text String

In the present Example, entities were comprised of sets of distinct text characters generated and selected for printing using high-level matrix-based programming software (MATLAB) and an inkjet printer in order to simulate a method for printing encoded images. The digital image consisted of a text string printed as a standard document.

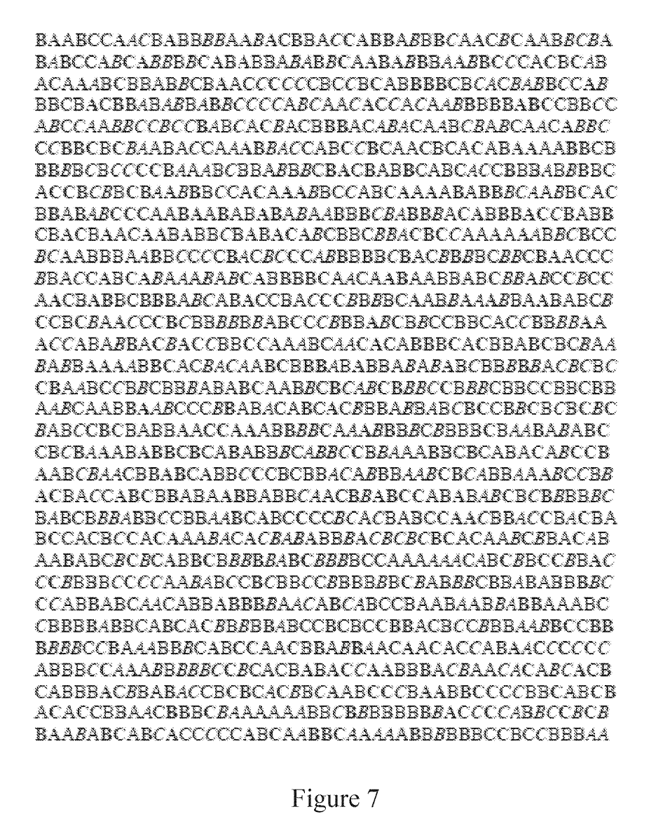

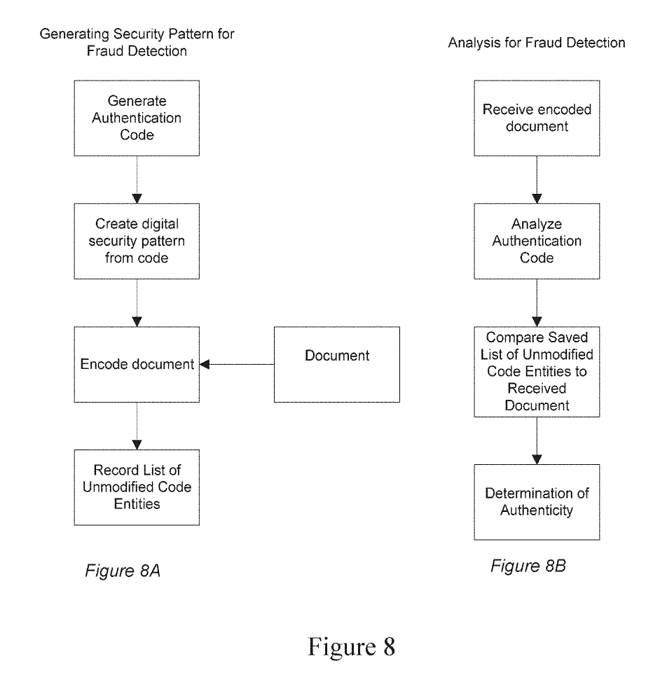

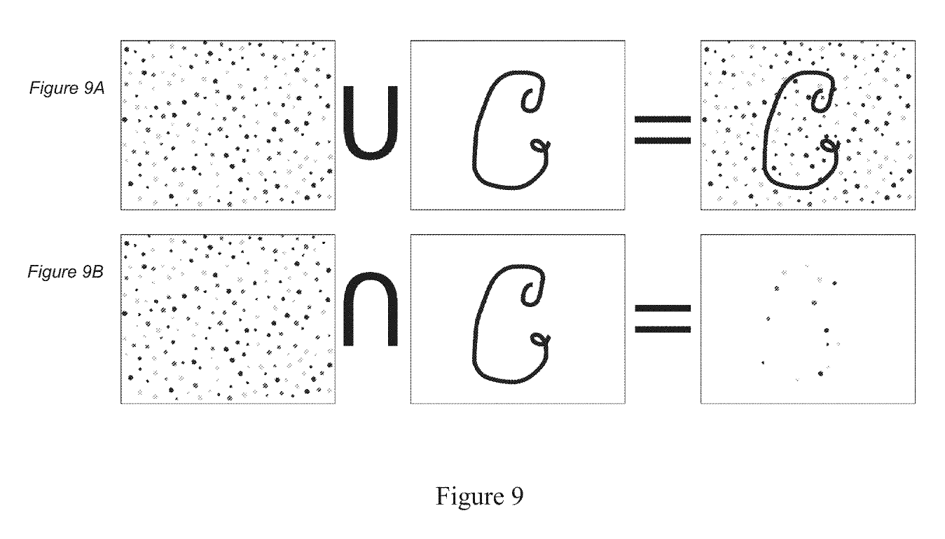

Similar to the previous examples, the text characters were manipulated (font color) to generate a library of cluster elements. In contrast to Examples 1 and 2, the spatial arrangement of cluster elements in Example 3 is not randomized; each of the text characters was randomly assigned one of three font features consisting of bold font, italicized font, and normal font. The feature-assigned (i.e. bold, italicized or normal) text characters were randomly ordered and then arranged in a single string. This string was then rendered in an HTML document with all encoding properties of the text present (i.e. text characters with assigned font features). FIG. 7 shows the output encoded text string, wherein there are three different types of characters represented (A, B, and C) and each individual occurrence of a character is represented with one of three font features (bold, italicized and normal). The resulting string contains the same code listed in Table 3.

An encoded text string could also serve as a substitute for the inverted encoded image described in Example 2. The encoded text string could be rendered in a manner that creates a larger pattern by distributing the text code in select regions. This method of patterning would be desirable when including encoded regions in regions that are aesthetically pleasing to or otherwise add function for the consumer or end user. For example, the encoded text string could be patterned so that it creates a logo or contains additional information that one would intend to be covert, such as identification numbers, camouflage, instructions for use, etc.

One of ordinary skill in the art recognizes that widely available methods, like flatbed scanning and optical character recognition, provide means for classifying entities in their corresponding cluster, and hence as a means for revealing the frequency array authentication and item identification code carried by text strings generated according to this Example 3.

One of ordinary skill in the art recognizes that the product authentication code can be any pattern or other layer applied to a document. In some embodiments, the pattern is an ordered pattern. In other embodiments, the pattern is a randomized pattern. In some embodiments, the document starting material such as document paper or a template can be purchased with one or more layers already applied or in existence. One or more layers can additionally be applied to the paper, for example to create an item identifier.

One of ordinary skill in the art recognizes that if the arrangement of entities generated in this Example 3 was randomized according to the method described in Example 1, each execution of the algorithm would yield a unique set of character strings in one dimension or groups of characters in a two-dimensional area. Such a unique image results in a memorialization of each execution, or “instance” of recreating the same product authentication code. Moreover, it is apparent to one of ordinary skill in the art that when entities are rendered as characters, relatively short strings of characters or small areas of characters provide item identification information. It is further noted that one of ordinary skill in the art recognizes that the product authentication code can be linked to at least one element of a digital security system.

### EXAMPLE 4

### Signature Authentication

In the present Example, the digital code described in Example 1 was used as a basis for signature authentication. An algorithm for signature authentication is described in FIG. 8, including an algorithm for generating a security pattern for fraud detection (FIG. 8A) and an algorithm for performing analysis for fraud detection (FIG. 8B).

Briefly, a digital image containing the same code listed in Table 3 was generated. The inverse of this code was taken by inverting the intensity scale of each pixel such that the pixels with value 0 were assigned the value 255, the pixels with the value 255 were assigned the value 0, and all remaining pixels were assigned new values according to this scale.

The encoded identifier, or product identification code, is created in a process summarized by FIG. 9A. First, the inverted encoded image is generated. Next, a signature is added to the inverted encoded image. The signature can be generated in multiple ways, including but not limited to machine-printing the inverted encoded image, manually signing it in ink, or overlaying a digital signature upon the inverted encoded image. Regardless of the method, the resulting encoded signature is comprised of the union (as is typically defined in set theory) of the inverted encoded image and the signature.

The method of encoded signature authentication is illustrated in FIG. 9B. The unique identifier is derived from the intersection (again, per set theory) of cluster elements in the inverted encoded image and the signature. In other words, the unique identifier is determined by recording the pixels that are present in both the cluster elements and the signature “ink,” whether the ink is physical ink applied to a digital image or a digital pixel array. The union can be limited to either the union of signature pixels with inverted encoded image pixels only or the union of signature pixels with whole cluster elements. In the case of a union including whole entities, it is possible that the code will include pixels of cluster elements that are not “obscured” by the signature “ink,” but instead belong to the cluster element with pixels that are obscured by the signature “ink”.

Item-level identification is achieved by recording the unique inverted encoded image and the output from the intersection calculation. Any subsequent calculation of the union of inverted encoded image and signature will reveal the unique item-level identification, which can be compared with the original recorded identifier. Recording the unique identifier at the signed document's point of origin and tracking it using a secure database detects alteration or duplication of signed documents.

FIG. 8 shows a flow-chart illustrating the process for using encoded images as security patterns to detect alteration of various items such as signatures and document contents.

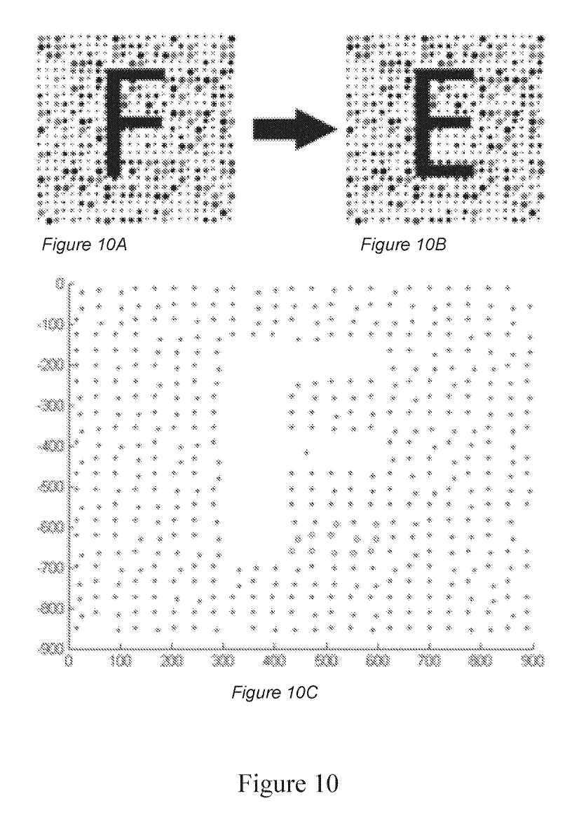

Those of ordinary skill in the art would infer that encoding is not limited to signatures. Printed and non-printed material can also be encoded using similar methodology as indicated in FIG. 10. Fraudulent alteration of this material could readily be detected by analysis of the encoded field observing the difference between the record of entities known to be modified and the absence or presence of additional entities.

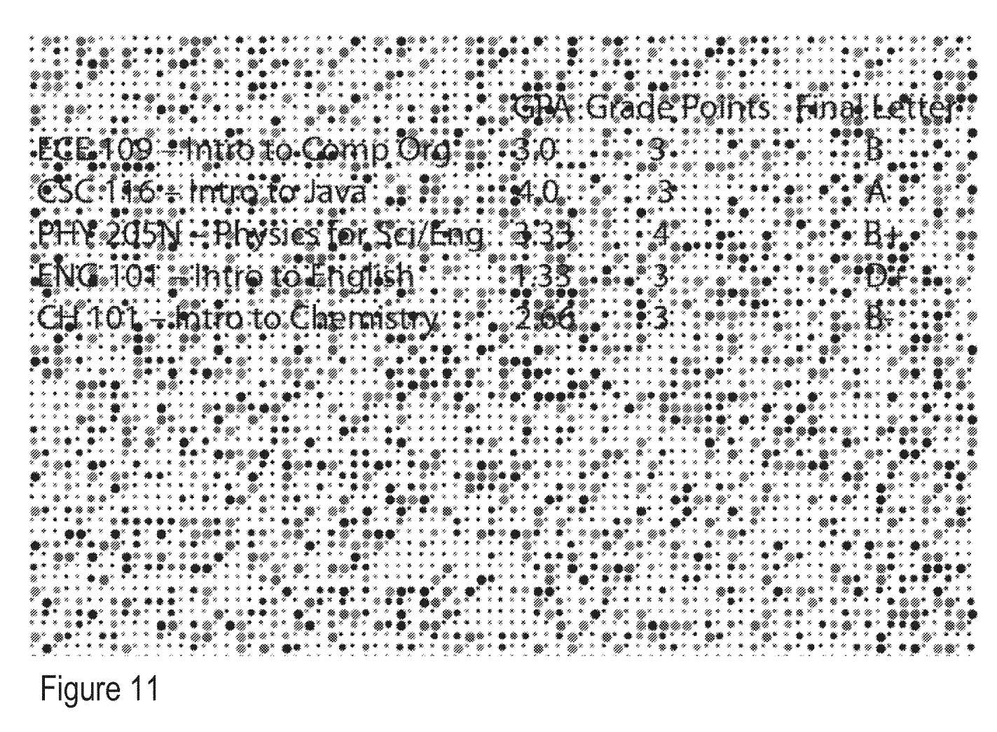

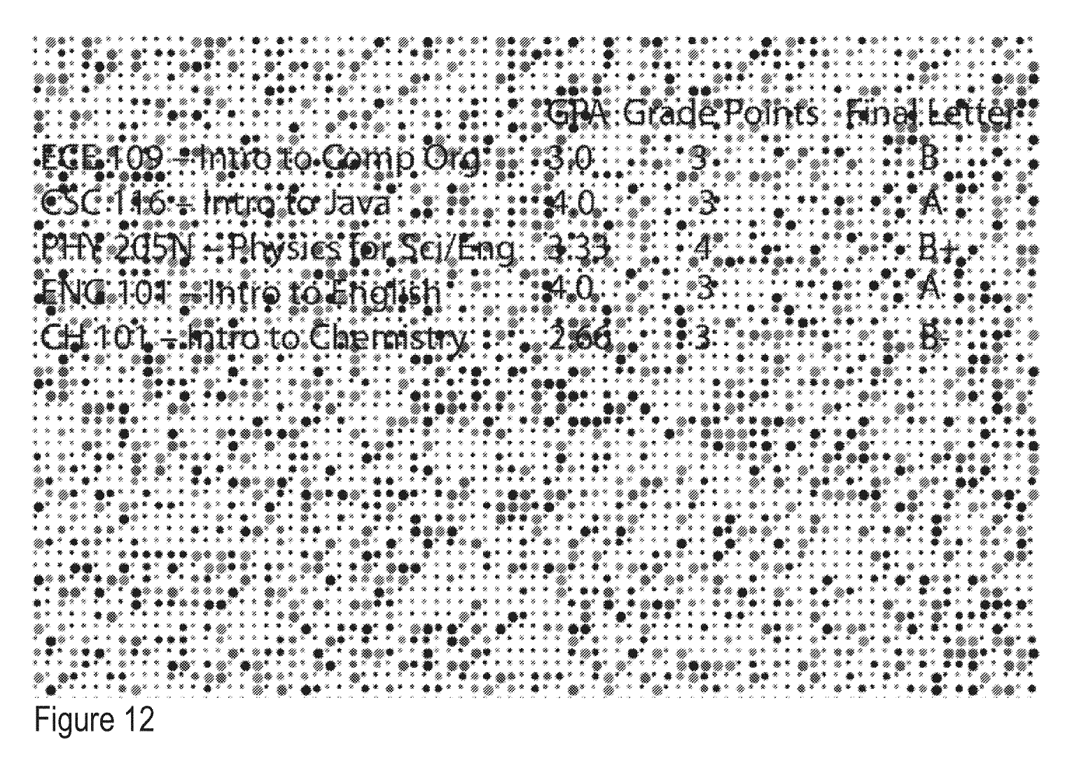

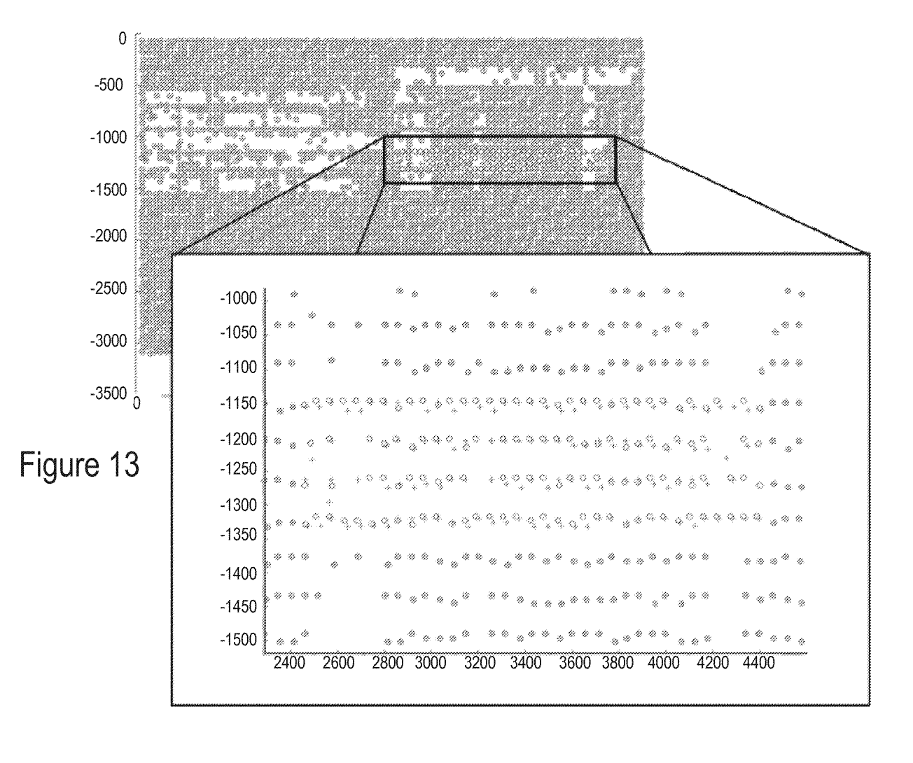

One of ordinary skill in the art can see based on FIG. 10 that there is an optimal relationship between size of entities and size of text in a field. FIG. 10 demonstrates the principle of using an encoded field to detect fraud without observing sensitive document contents. An effective demonstration of the use of this method for securing text within a document is seen in FIG. 11, FIG. 12 and FIG. 13.

An encoded text string (as mentioned in Example 3) could also serve as a substitute for the inverted encoded image described in this Example 4. The encoded text string could be used as an encoded entity over which a signature is applied. The intersection of the encoded text string and the signature would again serve as a unique identifier, and item authentication would be similar to the process described for the inverted encoded image.

FIG. 10A shows a digitally created letter “F” printed on an encoded field. Similar to what is shown in FIG. 9, the interaction of entities within the field and the printed letter are recorded for FIG. 10A. FIG. 10B shows an example of a user fraudulently modifying the letter “F” to resemble the letter “E”. However, FIG. 10C shows how the fraudulent activity is detected in the methods and systems of the present invention. When the encoded field containing the fraudulent “E” is analyzed, entities originally recorded as modified are represented by the symbol “+” (compare to FIG. 10A) while the entities that were fraudulently modified (as shown in FIG. 10B) are represented as “o”. Thus, to the methods and systems of the present invention enable detection of modifications or alterations to the letter “F” as it was originally placed on the encoded field.

FIG. 11 shows a document, wherein the document is an academic transcript containing course, grade and grade point information placed over an encoded field. FIG. 12 shows a fraudulent alteration of the document from FIG. 11, wherein the grade for course ENG101 has been changed from a D− to an A. FIG. 13 shows a partially exploded view of a visual representation of fraud analysis where the misalignment of the “+” symbols and the “o” symbols represent the differing lists of entities from the original unaltered document from FIG. 11 as compared to the fraudulently altered document from FIG. 12.

One of ordinary skill in the art recognizes that the product authentication code can be any pattern or other layer applied to a document. In some embodiments, the pattern is an ordered pattern. In other embodiments, the pattern is a randomized pattern. In some embodiments, the document starting material such as document paper or a template can be purchased with one or more layers already applied or in existence. One or more layers can additionally be applied to the paper, for example to create an item identifier.

One of ordinary skill in the art recognizes that since the arrangement of entities generated in this Example 4 is randomized according to the method described in Example 1, each execution of the algorithm yields a unique encoded image. Such a unique image results in a memorialization of each execution, or “instance” of recreating the same code. Moreover, it is apparent to one of ordinary skill in the art that when entities are rendered as symbols as in this Example 4, relatively short strings of symbols or small areas of symbols in the pattern space provide item identification information. Additionally, the union set between signature or printed text and code will be unique and can serve as a unique identifier between instances of a code plus signature or code plus text combination. It is further noted that one of ordinary skill in the art recognizes that the product authentication code can be linked to at least one element of a digital security system.

Encoded identifiers, or item identifiers, have numerous applications. Digitally-encoded images can be readily incorporated into printed stock material, including packaging, boxes, tapes, bags, and films. Personal identification documents such as drivers' licenses and passports would benefit from the inclusion of printed authentication codes. Similarly, currency (cash, coins, checks, bank notes, bonds, etc.) would benefit from surface modification as described in the encoded image examples. Medical devices, likewise, would benefit from item authentication for purposes of item tracking (implants) and identification of counterfeit, stolen, or diverted products (narcotic drug delivery devices such as DURAGESIC® brand fentanyl patches). In the food safety, the implementation of encoded identifiers would be helpful in determining the pedigree of ingredient sources and mitigating recalls and reducing illness due to food-borne pathogens such as E. coli. Military food and other supplies could be tested for safety prior to consumption or use. Luxury items, similar to the case of prescription narcotics, are highly counterfeited; these items would also benefit from the counterfeit deterrent effect of product authentication.

Legal documents (wills, titles, contracts, etc.) that must include a signature would benefit from signature verification, particularly in the instance where a deceased signer as in the case of wills cannot verify the document's authenticity.

Those of ordinary skill in the art can use microdots with alternative construction. For example, the microdot's color or size may replace grayscale.

One of ordinary skill in the art recognizes that printing a code of the present invention is not limited to the backing layer of a transdermal patch. A variety of other suitable surfaces for printing said code can be found on product packages, containers (such as the vials or prepackaged syringes), on medical devices (such as in the coating of stents or on the casing of implantable defibrillators).

Those of ordinary skill in the art can use microdots with alternative construction, or other entities, such as microparticles (embedded or affixed in a suitable binding matrix) to label the stoppers in this example. Additionally, the skilled artisan recognizes that other components of the packaging are suitable for labeling with the frequency array or that RFID or other known product authentication technology may be used in conjunction with a liquid suspension and particulate arrays like the ones described in the above Examples.

While the foregoing specification teaches the principles of the present invention, with examples provided for the purpose of illustration, it will be understood that the practice of the invention encompasses all of the usual variations, adaptations and/or modifications as come within the scope of the following claims and their equivalents.

1. A method of operating a device, comprising:
assigning, by the device, a digital content layer to a reference product, wherein the digital content layer is human-readable and corresponds to one or more of textual and graphical content on the reference product;
assigning, by the device, a digital code layer comprising a plurality of symbols to the reference product, wherein the plurality of symbols is machine-readable via an optical reader;
merging, by the device, using one or more digital image processing techniques, the digital content layer with the digital code layer to form a reference product merged layer, wherein the digital content layer and the digital code layer are separate layers, both separate layers are visible, the digital code layer remains machine-readable in the reference product merged layer, and the digital content layer remains human-readable in the reference product merged layer;
determining, by the device, employing an optical reader and using the one or more digital image processing techniques applied to the reference product merged layer, a reference identifier, the reference identifier determined based on at least one symbol of the digital code layer and at least one character of the digital content layer;
determining, by the device, employing the optical reader and using the one or more digital image processing techniques applied to a candidate product merged layer, a candidate identifier;
performing, by the device, a comparison of the reference identifier and the candidate identifier;
determining, by the device, based on the comparison of the reference identifier and the candidate identifier, that the candidate product is the reference product when the reference identifier matches the candidate identifier;
assigning, by the device, at least one additional digital content layer to the reference product to produce at least one additional reference identifier; and
determining, by the device, employing the optical reader and using the one or more digital image processing techniques applied to the candidate product merged layer, at least one additional candidate identifier,
wherein determining that the candidate product is the reference product comprises comparing the at least one additional reference identifier and the at least one additional candidate identifier.

2. The method of claim 1, wherein the reference product is a prescription for a pharmaceutical product.

3. The method of claim 1, wherein the reference product is a document.

4. The method of claim 1, wherein the content is one or more of textual and graphical and functional on its own.

5. The method of claim 1, wherein the digital content layer and the digital code layer are spatially overlapping on the reference product.

6. The method of claim 1, wherein assigning the digital code layer to the reference product comprises assigning a unique digital code layer that is unique to a single instance of the reference product.

7. The method of claim 1, wherein assigning the digital code layer is performed separately to assigning the digital content layer.

8. The method of claim 1, further comprising:
assigning, by the device, at least one additional digital content layer to the reference product to produce at least one additional reference identifier; and
determining, by the device, using the one or more digital image processing techniques applied to the candidate product merged layer, at least one additional candidate identifier,
wherein determining that the candidate product is the reference product comprises comparing the reference identifier to the candidate identifier and comparing the at least one additional reference identifier with the at least one additional candidate identifier.

9. The method of claim 1, wherein determining that the candidate product is the reference product based on comparison of the reference identifier and the candidate identifier further detects a change in the digital content layer.

10. The method of claim 1, wherein analyzing the reference product merged layer to produce the reference identifier comprises analyzing a portion of the digital code layer with the digital content layer.

11. A method of operating a device, comprising:
assigning, by the device, a digital content layer to a reference product, wherein the digital content layer is human-readable and corresponds to one or more of textual and graphical content on the reference product;
determining a frequency array, wherein the frequency array is chosen to be unique among all previously determined frequency arrays;
assigning, by the device, the frequency array to the reference product as a digital code layer, wherein the digital code layer is machine readable an optical reader;
merging, by the device, using one or more digital image processing techniques, the digital content layer with the digital code layer to form a reference product merged layer, wherein the digital content layer and the digital code layer are separate layers, both separate layers are visible, the digital code layer remains machine-readable in the reference product merged layer, and the digital content layer remains human-readable in the reference product merged layer;
determining, by the device, employing an optical reader and using the one or more digital image processing techniques applied to the reference product merged layer, a reference identifier, the reference identifier determined based on at least one symbol of the digital code layer to at least one character of the digital content layer;
determining, by the device, employing the optical reader and using one or more digital image processing techniques applied to a candidate product merged layer, a measured candidate digital code layer and a candidate identifier;
assigning, by the device, at least one additional digital content layer to the reference product to produce at least one additional reference identifier;
determining, by the device, employing the optical reader and using the one or more digital image processing techniques applied to the candidate product merged layer, at least one additional candidate identifier;
performing, by the device, a comparison of the at least one additional candidate identifier to the reference identifier; and
determining, by the device, based on the comparison of the reference identifier and the at least one additional candidate identifier, that the candidate product is the reference product when the reference identifier matches the at least one additional candidate identifier.

12. The method of claim 11, wherein, the reference identifier is unique to an instance of that product, and further comprising identifying an individual instance of an authenticated product.

13. The method of claim 11, wherein the frequency array is logically linked to at least one element of a digital security system.

14. The method of claim 13, wherein identifying the individual instance of the authenticated product comprises identifying a specific manifestation of the frequency array associated with the individual instance of the authenticated product.

15. The method of claim 14, wherein the frequency array is logically linked to at least one element of a digital security system.

16. The method of claim 15, wherein identifying the individual instance of the authenticated product comprises:
assigning, by the device, the digital content layer to the reference product;
analyzing, by the device, an interaction of the digital code layer with the digital content layer; and
identifying, by the device, the individual instance of the authenticated product based on the interaction of the digital code layer and the digital content layer.

17. The method of claim 16, further comprising:
assigning, by the device, at least one additional digital content layer to the reference product; and
identifying, by the device, the individual instance of the authenticated product based on the interaction of any combination of the digital content layer, digital code layer, and any additional digital content layers.
